(19) United States
(12) Patent Application Publication
(10) Pub. No.: US 2013/0329663 A1
(43) Pub. Date: Dec. 12, 2013

(54) METHOD AND APPARATUS FOR CONTROLLING UPLINK MULTIPLE-INPUT MULTIPLE-OUTPUT (MIMO) TRANSMISSIONS

(71) Applicant: INTERDIGITAL PATENT HOLDINGS, INC., Wilmington, DE (US)

(72) Inventors: Benoit Pelletier, Montreal (CA); Diana Pani, Montreal (CA)

(21) Appl. No.: 13/915,028

(22) Filed: Jun. 11, 2013

Related U.S. Application Data
(60) Provisional application No. 61/658,726, filed on Jun. 12, 2012.
(60) Provisional application No. 61/675,978, filed on Jul. 26, 2012.
(60) Provisional application No. 61/718,567, filed on Oct. 25, 2012.

(51) Int. Cl. H04W 72/04

(52) U.S. Cl. CPC H04W 72/0413
USPC 370/329

(57) ABSTRACT

A method and apparatus for controlling uplink (UL) multiple-input multiple-output (MIMO) transmission parameters and transmissions are disclosed. A wireless transmit/receive unit (WTRU) may determine parameters, such as block sizes or transport format combinations, for transmission of a plurality of streams. The WTRU may adjust the transmission power to ensure that dedicated physical data channels are transmitted at the same level on both streams while using a WTRU calculated virtual grant on a secondary stream.

### CROSS REFERENCE TO RELATED APPLICATIONS

This application claims the benefit of U.S. Provisional Application No. 61/658,726, filed Jun. 12, 2012, U.S. Provisional Application No. 61/675,978, filed Jul. 26, 2012, and U.S. Provisional Application No. 61/718,567, filed Oct. 25, 2012, the contents of which are hereby incorporated by reference herein.

### BACKGROUND

The evolution of the universal mobile telecommunication systems (UMTS) wideband code division multiple access (W-CDMA) standards on uplink transmission rates are imbalanced versus downlink transmission rates. Multiple-input multiple-output (MIMO) technologies have been considered on the uplink for increasing the peak data rate on the uplink.

### SUMMARY

A method and apparatus for controlling uplink (UL) multiple-input multiple-output (MIMO) transmission parameters and transmissions are disclosed. A wireless transmit/receive unit (WTRU) may determine parameters, such as block sizes or transport format combinations, for transmission of a plurality of streams. The WTRU may adjust the transmission power to ensure that dedicated physical data channels are transmitted at the same level on both streams while using a WTRU calculated virtual grant on a secondary stream.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows how a non-scheduled grant may impact transmitted power;

FIG. 3A shows a process for enhanced dedicated channel (E-DCH) transport format combination (E-TFC) selection;

FIG. 3B shows a process to determine a rank for an uplink MIMO transmission;

FIG. 3C shows a process to determine E-TFCs for a primary stream and a secondary stream; and

FIG. 4 shows an example of determining when a WTRU is happy/unhappy with uplink resources allocated for MIMO transmissions.

### DETAILED DESCRIPTION

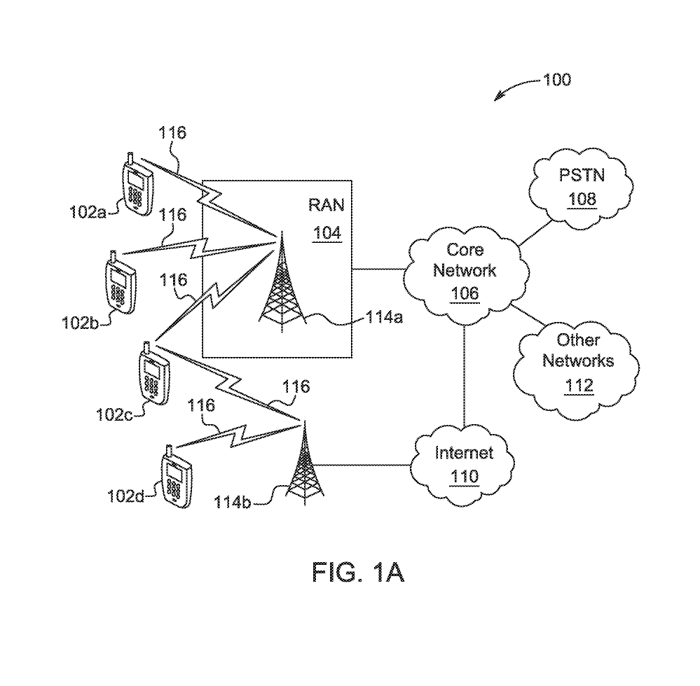

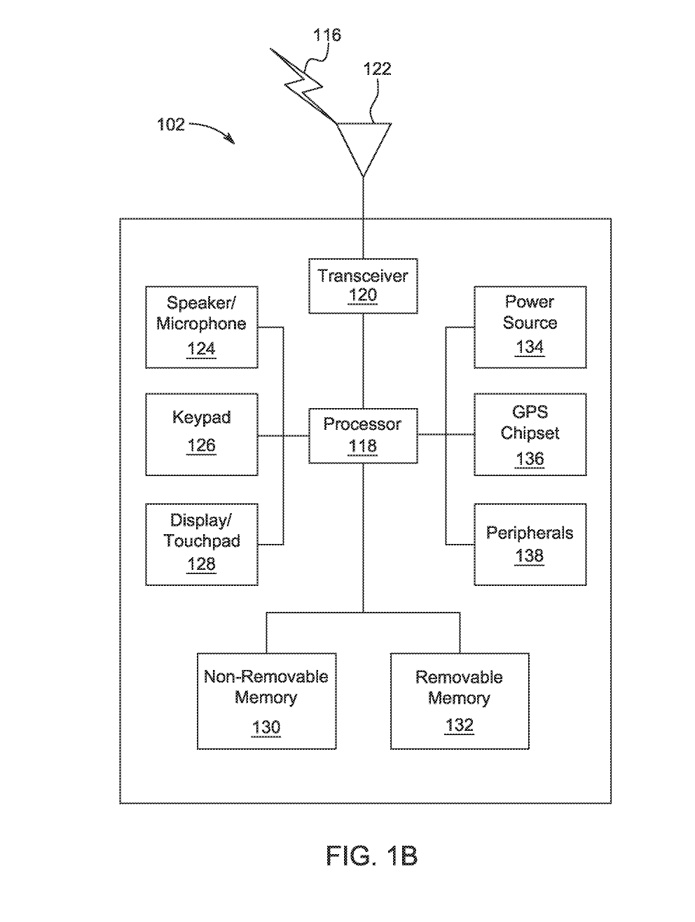

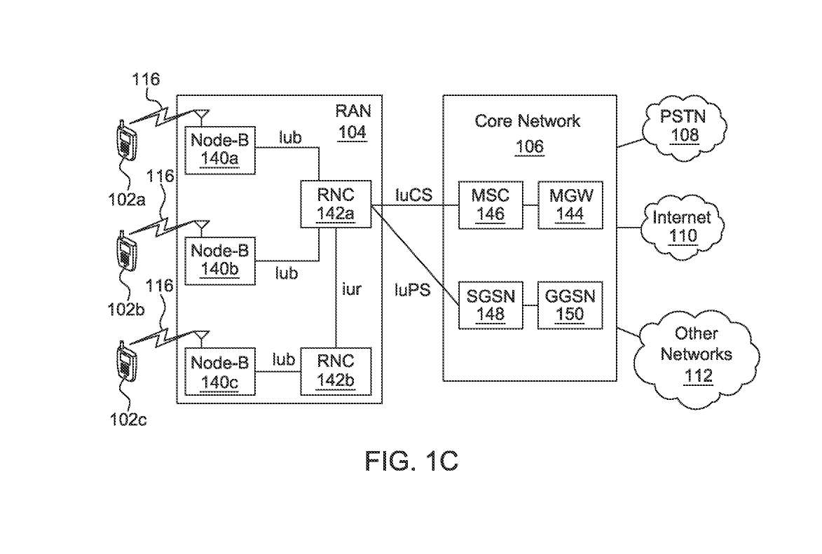

FIG. 1A is a diagram of an example communications system 100 in which one or more disclosed embodiments may be implemented. Communications system 100 may be a multiple access system that provides content, such as voice, data, video, messaging, broadcast, etc., to multiple wireless users. Communications system 100 may enable multiple wireless users to access such content through the sharing of system resources, including wireless bandwidth. For example, communications system 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of WTRUs 102a, 102b, 102c, 102d may be any type of device configured to operate and/or communicate in a wireless environment. By way of example, WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

Communications system 100 may also include a base station 114a and a base station 114b. Each of base stations 114a, 114b may be any type of device configured to wirelessly interface with at least one of WTRUs 102a, 102b, 102c, 102d to facilitate access to one or more communication networks, such as core network 106, Internet 110, and/or other networks 112. By way of example, base stations 114a, 114b may be a base transceiver station (BTS), a Node-B, an eNode-B, a Home Node-B, a Home eNode-B, a site controller, an access point (AP), a wireless router, and the like. While base stations 114a, 114b are each depicted as a single element, it will be appreciated that base stations 114a, 114b may include any number of interconnected base stations and/or network elements.

Base station 114a may be part of RAN 104, which may also include other base stations and/or network elements (not shown), such as a base station controller (BSC), a radio network controller (RNC), relay nodes, etc. Base station 114a and/or base station 114b may be configured to transmit and/or receive wireless signals within a particular geographic region, which may be referred to as a cell (not shown). The cell may further be divided into cell sectors. For example, the cell associated with base station 114a may be divided into three sectors. Thus, in one embodiment, base station 114a may include three transceivers, i.e., one for each sector of the cell. In another embodiment, base station 114a may employ multiple-input multiple-output (MIMO) technology and, therefore, may utilize multiple transceivers for each sector of the cell.

Base stations 114a, 114b may communicate with one or more of WTRUs 102a, 102b, 102c, 102d over an air interface 116, which may be any suitable wireless communication link (e.g., radio frequency (RF), microwave, infrared (IR), ultraviolet (UV), visible light, etc.). Air interface 116 may be established using any suitable radio access technology (RAT).

More specifically, as noted above, communications system 100 may be a multiple access system and may employ one or more channel access schemes, such as CDMA, TDMA, FDMA, OFDMA, SC-FDMA, and the like. For example, base station 114a in RAN 104 and WTRUs 102a, 102b, 102c may implement a radio technology such as Universal Mobile Telecommunications System (UMTS) Terrestrial Radio Access (UTRA), which may establish air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, base station 114a and WTRUs 102a, 102b, 102c may implement a radio technology such as Evolved UMTS Terrestrial Radio Access (E-UTRA), which may establish air interface 116 using Long Term Evolution (LTE) and/or LTE-Advanced (LTE-A).

In other embodiments, base station 114a and WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

Base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, and the like. In one embodiment, base station 114b and WTRUs 102c, 102d may implement a radio technology such as IEEE 802.11 to establish a wireless local area network (WLAN). In another embodiment, base station 114b and WTRUs 102c, 102d may implement a radio technology such as IEEE 802.15 to establish a wireless personal area network (WPAN). In yet another embodiment, base station 114b and WTRUs 102c, 102d may utilize a cellular-based RAT (e.g., WCDMA, CDMA2000, GSM, LTE, LTE-A, etc.) to establish a picocell or femtocell. As shown in FIG. 1A, base station 114b may have a direct connection to Internet 110. Thus, base station 114b may not be required to access Internet 110 via core network 106.

RAN 104 may be in communication with core network 106, which may be any type of network configured to provide voice, data, applications, and/or voice over internet protocol (VoIP) services to one or more of WTRUs 102a, 102b, 102c, 102d. For example, core network 106 may provide call control, billing services, mobile location-based services, pre-paid calling, Internet connectivity, video distribution, etc., and/or perform high-level security functions, such as user authentication. Although not shown in FIG. 1A, it will be appreciated that RAN 104 and/or core network 106 may be in direct or indirect communication with other RANs that employ the same RAT as RAN 104 or a different RAT. For example, in addition to being connected to RAN 104, which may be utilizing an E-UTRA radio technology, core network 106 may also be in communication with another RAN (not shown) employing a GSM radio technology.

Core network 106 may also serve as a gateway for WTRUs 102a, 102b, 102c, 102d to access PSTN 108, Internet 110, and/or other networks 112. PSTN 108 may include circuit-switched telephone networks that provide plain old telephone service (POTS). Internet 110 may include a global system of interconnected computer networks and devices that use common communication protocols, such as the transmission control protocol (TCP), user datagram protocol (UDP) and the internet protocol (IP) in the TCP/IP internet protocol suite. Networks 112 may include wired or wireless communications networks owned and/or operated by other service providers. For example, networks 112 may include another core network connected to one or more RANs, which may employ the same RAT as RAN 104 or a different RAT.

Some or all of WTRUs 102a, 102b, 102c, 102d in the communications system 100 may include multi-mode capabilities, i.e., WTRUs 102a, 102b, 102c, 102d may include multiple transceivers for communicating with different wireless networks over different wireless links. For example, WTRU 102c shown in FIG. 1A may be configured to communicate with base station 114a, which may employ a cellular-based radio technology, and with base station 114b, which may employ an IEEE 802 radio technology.

FIG. 1B is a system diagram of an example WTRU 102. As shown in FIG. 1B, WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that WTRU 102 may include any sub-combination of the foregoing elements while remaining consistent with an embodiment.

Processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. Processor 118 may perform signal coding, data processing, power control, input/output processing, and/or any other functionality that enables WTRU 102 to operate in a wireless environment. Processor 118 may be coupled to transceiver 120, which may be coupled to transmit/receive element 122. While FIG. 1B depicts processor 118 and transceiver 120 as separate components, it will be appreciated that processor 118 and transceiver 120 may be integrated together in an electronic package or chip.

Transmit/receive element 122 may be configured to transmit signals to, or receive signals from, a base station (e.g., base station 114a) over air interface 116. For example, in one embodiment, transmit/receive element 122 may be an antenna configured to transmit and/or receive RF signals. In another embodiment, transmit/receive element 122 may be an emitter/detector configured to transmit and/or receive IR, UV, or visible light signals, for example. In yet another embodiment, transmit/receive element 122 may be configured to transmit and receive both RF and light signals. It will be appreciated that transmit/receive element 122 may be configured to transmit and/or receive any combination of wireless signals.

In addition, although transmit/receive element 122 is depicted in FIG. 1B as a single element, WTRU 102 may include any number of transmit/receive elements 122. More specifically, WTRU 102 may employ MIMO technology. Thus, in one embodiment, WTRU 102 may include two or more transmit/receive elements 122 (e.g., multiple antennas) for transmitting and receiving wireless signals over air interface 116.

Transceiver 120 may be configured to modulate the signals that are to be transmitted by transmit/receive element 122 and to demodulate the signals that are received by transmit/receive element 122. As noted above, WTRU 102 may have multi-mode capabilities. Thus, transceiver 120 may include multiple transceivers for enabling WTRU 102 to communicate via multiple RATs, such as UTRA and IEEE 802.11, for example.

Processor 118 of WTRU 102 may be coupled to, and may receive user input data from, speaker/microphone 124, keypad 126, and/or display/touchpad 128 (e.g., a liquid crystal display (LCD) display unit or organic light-emitting diode (OLED) display unit). Processor 118 may also output user data to speaker/microphone 124, keypad 126, and/or display/touchpad 128. In addition, processor 118 may access information from, and store data in, any type of suitable memory, such as non-removable memory 130 and/or removable memory 132. Non-removable memory 130 may include random-access memory (RAM), read-only memory (ROM), a hard disk, or any other type of memory storage device. Removable memory 132 may include a subscriber identity module (SIM) card, a memory stick, a secure digital (SD) memory card, and the like. In other embodiments, processor 118 may access information from, and store data in, memory that is not physically located on WTRU 102, such as on a server or a home computer (not shown).

Processor 118 may receive power from power source 134, and may be configured to distribute and/or control the power to the other components in WTRU 102. Power source 134 may be any suitable device for powering WTRU 102. For example, power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

Processor 118 may also be coupled to GPS chipset 136, which may be configured to provide location information (e.g., longitude and latitude) regarding the current location of WTRU 102. In addition to, or in lieu of, the information from GPS chipset 136, WTRU 102 may receive location information over air interface 116 from a base station (e.g., base stations 114a, 114b) and/or determine its location based on the timing of the signals being received from two or more nearby base stations. It will be appreciated that WTRU 102 may acquire location information by way of any suitable location-determination method while remaining consistent with an embodiment.

Processor 118 may further be coupled to other peripherals 138, which may include one or more software and/or hardware modules that provide additional features, functionality and/or wired or wireless connectivity. For example, peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of RAN 104 and core network 106 according to an embodiment. As noted above, RAN 104 may employ a UTRA radio technology to communicate with WTRUs 102a, 102b, 102c over air interface 116. RAN 104 may also be in communication with core network 106. As shown in FIG. 1C, RAN 104 may include Node-Bs 140a, 140b, 140c, which may each include one or more transceivers for communicating with WTRUs 102a, 102b, 102c over air interface 116. Node-Bs 140a, 140b, 140c may each be associated with a particular cell (not shown) within RAN 104. RAN 104 may also include RNCs 142a, 142b. It will be appreciated that RAN 104 may include any number of Node-Bs and RNCs while remaining consistent with an embodiment.

As shown in FIG. 1C, Node-Bs 140a, 140b may be in communication with RNC 142a. Additionally, Node-B 140c may be in communication with RNC 142b. Node-Bs 140a, 140b, 140c may communicate with the respective RNCs 142a, 142b via an Iub interface. RNCs 142a, 142b may be in communication with one another via an Iur interface. Each of RNCs 142a, 142b may be configured to control the respective Node-Bs 140a, 140b, 140c to which it is connected. In addition, each of RNCs 142a, 142b may be configured to carry out or support other functionality, such as outer loop power control, load control, admission control, packet scheduling, handover control, macrodiversity, security functions, data encryption, and the like.

Core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of core network 106, it will be appreciated that any one of these elements may be owned and/or operated by an entity other than the core network operator.

RNC 142a in RAN 104 may be connected to MSC 146 in core network 106 via an IuCS interface. MSC 146 may be connected to MGW 144. MSC 146 and MGW 144 may provide WTRUs 102a, 102b, 102c with access to circuit-switched networks, such as PSTN 108, to facilitate communications between WTRUs 102a, 102b, 102c and traditional land-line communications devices.

RNC 142a in RAN 104 may also be connected to SGSN 148 in the core network 106 via an IuPS interface. SGSN 148 may be connected to GGSN 150. SGSN 148 and GGSN 150 may provide WTRUs 102a, 102b, 102c with access to packet-switched networks, such as Internet 110, to facilitate communications between and WTRUs 102a, 102b, 102c and IP-enabled devices.

As noted above, core network 106 may also be connected to networks 112, which may include other wired or wireless networks that are owned and/or operated by other service providers.

For enhanced dedicated channel (E-DCH) communications, WTRU 102 may receive a grant by a serving NodeB, such as any one of Node-Bs 140ₐ-140ₑ. This grant may be a right or permission to transmit at a certain power level and create interference in communications system 100. Because the NodeB may not have instantaneous and precise information about WTRU buffer and transmit power, WTRU 102 may determine the transmission parameters (e.g., power, transport format, and transport block size (TBS)) on a transmission time interval (TTI)-by-TTI basis with the restriction that the transmit power may be below what is allowed by the serving grant and WTRU 102 power capabilities (i.e., the power headroom).

For UL MIMO operations, WTRU 102 may determine the transmission parameters for the secondary stream. On a transmission time interval (TTI) by TTI basis, WTRU 102 may determine whether or not a rank-2 transmission is supported, the transmission power for the data channels, or the TBS on each stream. WTRU 102 may determine the transmission parameters based on its headroom, serving grant, secondary stream offset, buffer, etc. The rank of a channel matrix or a MIMO matrix H may define a number of linearly independent rows or columns. The rank may also indicate a number of independent data streams or layers that can be transmitted simultaneously by a device, such as WTRU 102. Transmission of the streams by WTRU 102 may be provided over two or more transmit/receive elements 122 (e.g., multiple antennas).

Examples are described for E-DCH transport format combination (E-TFC) selection and transmission parameter selection for UL MIMO operations with an E-DCH. While the examples are described in a particular context, it should be understood that the examples disclosed herein may be used in any order or combination, or may be used partially. It should be noted that the examples are applicable to any wireless communication systems. Moreover, although the examples forthcoming are provided in the context of an E-DCH transmission, the transport format may equally apply to any other channel or type of channel.

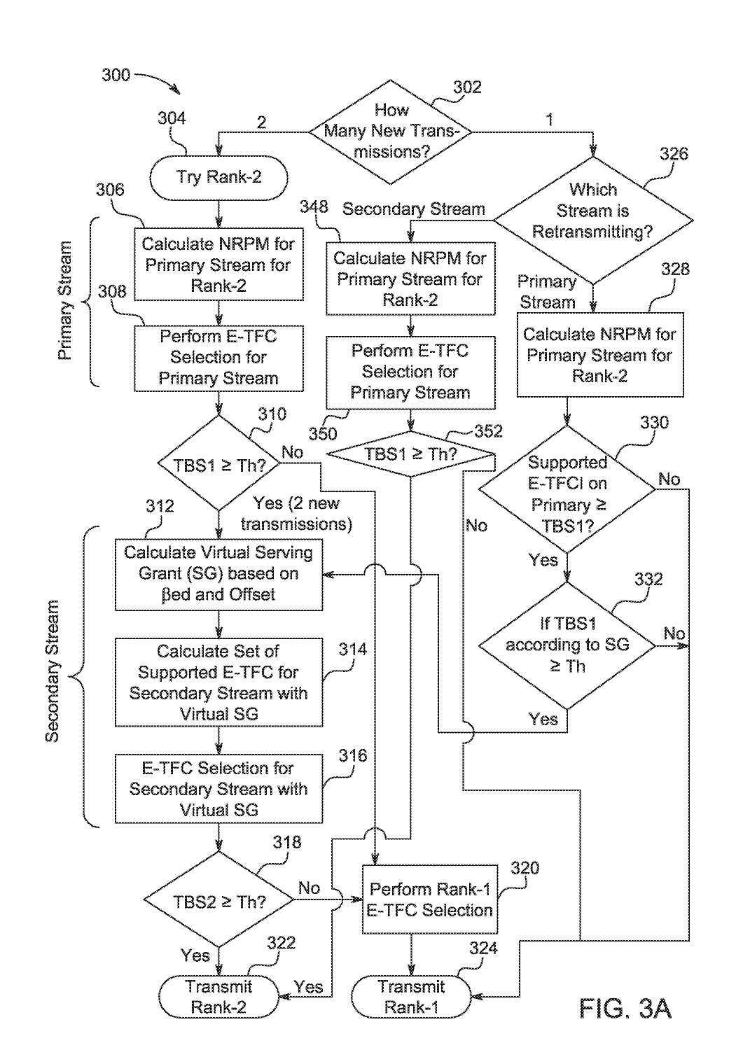

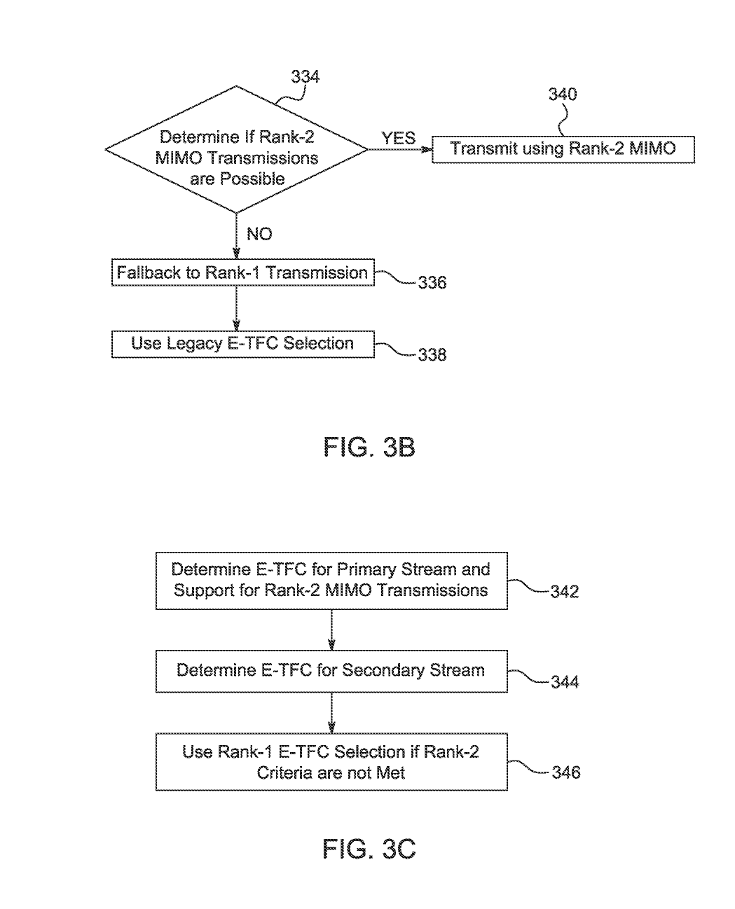

In accordance with the examples given henceforth, FIG. 3A shows a process 300 for E-DCH transport format combination (E-TFC) selection and transmit power determination that may be performed by WTRU 102 in coordination with any one of Node-Bs 140ₐ-140_{c}, such as a serving Node-B. WTRU 102 may support UL MIMO operations, may be configured for UL MIMO operations, have UL MIMO is enabled, and/or may have UL MIMO already activated. In the following descriptions and examples the term E-TFC and E-TFC index (E-TFCI) may be considered equivalent and used interchangeably.

WTRU 102 may determine a number of new transmissions to any one of Node-Bs 140ₐ-140_{c} (302). The determination by WTRU 102 may be performed for each TTI, selectively on a TTI basis, or any other time period. In the examples forthcoming, one or two new transmissions are used as an example. However, WTRU 102 may be configured for more than two MIMO streams and the examples forthcoming may be equally applied to more than two MIMO streams. For instance, two additional streams (i.e. rank-3) may be used in combination with a primary stream.

If two new transmissions are desired by WTRU 102 to any one of Node-Bs 140ₐ-140_{c}, WTRU 102 may attempt to configure the transmission as a rank-2 transmission (304). A new transmission may mean that WTRU 102 has a new transport block to transmit on a primary stream. For a second new transmission of a second transport block, WTRU 102 may attempt to transmit the second transport block on a secondary stream.

A normalized remaining power margin (NRPM) for the primary stream, with an assumption of a possible rank-2 transmission on the E-DCH, may then be calculated by WTRU 102 (306). WTRU 102 may subsequently perform an E-TFC selection procedure for the primary stream (308). The E-TFC selection procedure may be performed for the primary stream with an assumption of a possible rank-2 transmission on the E-DCH. In the E-TFC selection procedure, WTRU 102 calculates at least a transport block size of the primary stream (TBS1) and a gain factor β_{ed} for the primary stream.

If TBS1 is greater than or equal to a threshold value (310), rank-2 transmission for two new transmissions by WTRU 102 may be allowed. WTRU 102 may subsequently calculate a virtual serving grant for the secondary stream using gain factor β_{ed} for the primary stream and an offset parameter (312). The virtual serving grant (SG) may be calculated as given in equation (s) 6, 10, or 16 explained below, as desired. The offset parameter may be a power offset, a reference power offset, or a penalty offset as explained further herein.

WTRU 102 may also calculate a set of supported E-TFCs for the secondary stream based on or using the calculated virtual SG for the secondary stream (314). WTRU 102 may subsequently perform or execute an E-TFC selection for the secondary stream based on or using the virtual SG for the secondary stream (316). If a second TBS (TBS2) is greater than or equal to a threshold value (318), WTRU 102 may proceed to transmit on an E-DCH using or as a rank-2 MIMO (322). If TBS2 is less than the threshold value, WTRU 102 may perform or execute a rank-1 E-TFC selection procedure (320) and subsequently transmit on the E-DCH using or as a rank-1 MIMO (324).

If TBS1 is less than the threshold value (310), WTRU 102 may perform or execute a rank-1 E-TFC selection procedure (320). WTRU 102 may then subsequently transmit on the E-DCH using or as a rank-1 MIMO (324).

Referring back to WTRU 102 determining a number of new transmissions to any one of Node-Bs 140ₐ-140_{c} (302), if one new transmission is needed WTRU 102 may determine whether retransmission of data is needed on the secondary stream or primary stream (326). If it is the secondary stream, WTRU 102 may attempt a rank-2 MIMO transmission by calculating an NRPM for the primary stream with an assumption of a possible rank-2 transmission on an E-DCH (348).

WTRU 102 may subsequently perform an E-TFC selection procedure for the primary stream (350). The E-TFC selection procedure may be performed for the primary stream with an assumption of a possible rank-2 transmission on the E-DCH. If TBS1 is greater than or equal to a threshold value (352), WTRU 102 may proceed to transmit on an E-DCH using or as a rank-2 MIMO (322). If TBS1 is less than a threshold value (352), WTRU 102 may subsequently transmit on the E-DCH using or as a rank-1 MIMO (324).

If a retransmission is needed for the primary stream, an NRPM for the primary stream with the assumption of a possible rank-2 transmission on the E-DCH may then be calculated by WTRU 102 (328). WTRU 102 may then determine if a supported E-TFCI or E-TFC on the primary stream is greater than or equal to a transport block size TBS1 (330). If so, WTRU 102 checks if the maximum number of bits or TBS1 according to the SG on the primary stream is greater than or equal to a threshold value (332). If the maximum number of bits or TBS1 according to the SG for WTRU 102 is greater than a threshold value, WTRU 102 may calculate a virtual serving grant for the secondary stream using gain factor β_{ed} for the primary stream and an offset parameter (312). WTRU 102 may then proceed with determining (314, 316, 318) if a rank-2 or rank-1 transmission will take place (320, 322, 324) as previously explained.

If the supported E-TFCI or E-TFC on the primary stream is less than TBS1 (330) then WTRU 102 is configured to or may transmit as a rank-1 (324). If the maximum number of bits according to the SG on the primary stream is less than a threshold value (332) then WTRU 102 is configured to or may transmit as a rank-1 (324).

As previously explained, for E-TFC selection a WTRU may attempt rank-2 parameter selection and then, if WTRU 102 determines that it may not transmit with rank-2, WTRU 102 may fall back to rank-1 transmission and execute a regular E-TFC selection procedure. WTRU 102 may be configured to not transmit with rank-2 when one or more of the following conditions are violated (in any order or combination):
UL MIMO is enabled and activated, WTRU 102 has sufficient headroom (power) for UL MIMO transmission;
the selected TBS on a primary stream is above a minimum value; or
the selected TBS on a secondary stream is above a minimum value.

WTRU 102 may calculate a set of supported E-TFCs assuming rank-2 transmission. WTRU 102 may be configured to determine the set of supported E-TFC assuming rank-2 transmission for the primary stream, the secondary stream, or both. When assuming rank-2 transmission, WTRU 102 may be configured to use a rank-2 specific set of reference power offsets and E-DCH transport format combination index (E-TFCI), or WTRU 102 may be configured to apply a penalty offset to the existing set of reference power offsets.

In addition, WTRU 102 may determine the normalized remaining power margin (NRPM) for dual-stream transmissions by using the following formula for candidate E-TFCIj:

NRPMⱼ=(PMaxⱼ−P_{DPCCH,target}−P_{HS-DPCCH}−P_{E-DPCCH,j}−P_{S-E-DPCCH,j}−P_{S-DPCCH,j})/P_{DPCCH,target,} Equation (1)

where P_{S-E-DPCCH,j} is the power of the secondary E-DCH dedicated physical control channel (E-DPCCH), which may not depend on the E-TFCIⱼ, and P_{S-DPCCH,j} is the power of the secondary dedicated physical control channel (S-DPCCH) which may depend on the secondary stream E-TFCI or primary stream E-TFCI power. WTRU 102 may be configured to use a different PMaxⱼ depending on the transmission rank. Different NRPM values may be configured for rank-1 or rank-2 transmissions.

The power of the E-DCH dedicated physical data channel (E-DPDCH) and secondary E-DPDCH (S-E-DPDCH) may be equal and the set of E-TFCs supported for rank-2 transmission may be such that their relative power is at least twice the rank-2 NRPM, for example, as calculated in equation (1). For the primary stream, the set of supported E-TFCIs for rank-2 transmissions may be determined (for the non-compressed frame case) such that if NRPMᵢ≧2Σ(β_{ed,j}/β_{c})² then E-TFCⱼ may be supported on the primary stream with rank-2 transmission. Otherwise it may not be supported on the primary stream with rank-2 transmission. The gain factor β_{ed,j} for the E-DPDCH may be calculated using a different set of reference E-TFCI and power offsets, or using a configured rank-2 offset.

The supported E-TFCIs for the secondary stream may depend on the power headroom and on the secondary stream offset as signaled by any one of Node-Bs 140ₐ-140_{c}, such as the serving Node-B. This secondary stream offset controls WTRU 102's data rate on the secondary stream as the secondary stream may not be independently power controlled. As such, the gain factor for a candidate E-TFCI for the secondary stream may be calculated by taking into account the secondary stream offset. For example, this may be achieved by applying the offset to the extrapolation (or interpolation) formula as given below.

For the i^{th} E-TFC, the temporary variable β′_{ed,i,harq} for the secondary stream may be calculated as follows:

$${β}_{ed , i , harq}^{′} = {β}_{ed , ref} \sqrt{\frac{{L}_{e , ref}}{{L}_{e , i}}} \sqrt{\frac{{K}_{e , i}}{{K}_{e , ref}}} \cdot {10}^{( \frac{Δ harq}{20}} \cdot {10}^{( \frac{Δ offset}{20} )} , \qquad Equation ( 2 )$$

where Δoffset is the secondary stream offset signaled by any one of Node-Bs 140ₐ-140_{c}. The Node-B sending the offset may be the E-DCH serving cell Node-B for WTRU 102. Similar offset procedure may be applied when using the interpolation formula.

WTRU 102 may determine if a given E-TFCI on the secondary stream is supported by determining the NRPM and then if NRPMᵢ≧2Σ(β′_{ed,j}/β_{c})² then E-TFCⱼ may be supported on the secondary stream, otherwise it may not be supported on the secondary stream (for the non-compressed mode gap case). WTRU 102 may also be configured to determine a stream-specific value of the NRPM. For instance, WTRU 102 may be configured to calculate an NRPM for the primary stream (NRPM_{p,j}) and another NRPM for the secondary stream (NRPMs_{s,j}). In such cases, the NRPM values for the primary and/or secondary streams may not depend on E-TFCⱼ. For example, the NRPM for the primary and secondary stream may be calculated as follows:

$${NRPM}_{p , j} = {NRPM}_{s , j} = \frac{{NRPM}_{j}}{2} . \qquad Equation ( 3 )$$

WTRU 102 may determine if a given E-TFC on the primary stream is supported as follows: if NRPM_{p,i}≧Σ(β_{ed,j}/β_{c})² then E-TFCⱼ may be supported on the primary stream. Likewise for the secondary stream if NRPM_{s,i}≧Σ(β′_{ed,j}/β_{c})² then the E-TFCⱼ may be supported on the secondary stream.

A WTRU may determine the TBS for each stream independently. WTRU 102 may be configured to get the data from a buffer in non-removable memory 130 for one stream at a time (e.g., with the primary stream first). WTRU 102 may also determine the maximum supported payload for each stream based on the HARQ profile (i.e., the HARQ power offset) and the NRPM. WTRU 102 may perform E-TFC selection for each stream independently, e.g., starting with the primary stream.

WTRU 102 may use the most current value of the serving grant (SG) to calculate the maximum number of scheduled bits for each stream. Also, WTRU 102 may be configured with a single SG by the network. WTRU 102 may be configured to use this SG for the primary stream, regardless of a transmission rank. When transmitting with rank-2, WTRU 102 may use the same SG on the secondary stream, adjusted to account for the difference in channel conditions (via the secondary stream offset). For example, WTRU 102 may determine the maximum number of bits that can be transmitted according to the SG and the secondary power offset on the secondary stream as follows if the E-DPDCH power extrapolation formula is configured:

$$⌊ {K}_{e , ref , m} \cdot \frac{Serving\_Grant}{{L}_{e , ref , m} \cdot {A}_{ed , m}^{2} \cdot {10}^{Δ harq / 10} \cdot {10}^{Δ offset / 10}} ⌋ . \qquad Equation ( 4 )$$

This maximum number of bits may be lower than K_{e,ref,n} bits, where K_{e,ref,n} corresponds to any higher n^{th} rank-2 reference E-TFC (E-TFC_{ref,n}) and be higher or equal to K_{e,ref,m} of the rank-2 E-TFC_{ref,m} (except if m=1). The Δoffset may be signaled by the network. The rank-2 reference E-TFC may be the same as the rank-1 reference E-TFC.

A WTRU may determine the TBS for each stream in succession (e.g., primary stream first, and then secondary stream). WTRU 102 may also use the transmission parameters resulting from the E-TFC selection of the primary stream as input to the secondary stream E-TFC selection process. WTRU 102 may also start with the secondary stream and then use the transmission parameters from the secondary stream to determine the primary stream transmission parameters. For simplicity, the case where the primary stream may be considered first will be described in the following embodiments. However, it should be noted that the embodiments described below may also apply to the case where the secondary stream is considered first as well.

WTRU 102 may execute the E-TFC selection procedure for the secondary stream after determining that the result of the primary stream E-TFC selection allows rank-2 transmission. For example, WTRU 102 may determine that rank-2 transmission is allowed if the primary stream E-TFCI is equal to or above a threshold, or if the primary stream transport format (TF) is 2*SF₂+2*SF₄ (i.e., two channelization codes of spreading factor of 2 and two channelization codes of spreading factor of 4), or for example if the primary stream TBS is above a threshold variable.

WTRU 102 may determine whether rank-2 transmission is not allowed before selecting an E-TFCI for the primary stream. This may be performed, for example, by determining the maximum amount of bits that can be transmitted as allowed by the serving grant on the primary stream, wherein the maximum amount of bits that can be transmitted may be calculated assuming that a dual stream transmission (e.g., rank-2) would take place. In another example, WTRU 102 may add to the maximum number of bits that are allowed to be transmitted with the current serving grant the number of non-scheduled grants for the MAC-d flows that contain data and that are allowed to be transmitted in the current TTI with the current TTIs multiplexing restrictions. These values will be referred to as the maximum amount of bits that can be transmitted according to the allowed grants.

In another example, WTRU 102 may determine that rank-2 is not supported due to available power for rank-2 transmission. WTRU 102 may perform E-TFC restriction procedure assuming rank-2 transmission and determine the set of supported E-TFCIs for rank-2 transmissions on the primary stream. WTRU 102 may then determine that rank-2 transmission is allowed if the following conditions are met:
(1) the maximum amount of bits that can be transmitted according to the allowed grants is equal to or above a configured threshold or if the transport format of the highest transport block (TB) that can fit at least that amount of data corresponds to 2*SF₂+2*SF₄, and
(2) the maximum supported E-TFCI is equal to or above a configured threshold or if the transport format of the highest TB that can fit at least that amount of data corresponds to 2*SF₂+2*SF₄.

If one of the conditions above is not met, WTRU 102 may perform single stream E-TFCI selection without first determining an E-TFCI on the primary stream assuming rank-2. If both of the above conditions are met, WTRU 102 may perform E-TFCI selection for the primary stream assuming rank-2 transmissions and the rules specified above may be applied once WTRU 102 has determined the E-TFCI on the primary stream.

Once WTRU 102 has determined that the selected E-TFCI on the primary stream allows rank-2 transmission, WTRU 102 may be configured to use the primary stream transmission parameters to determine the secondary stream TBS. For example, WTRU 102 may use the value of the resulting primary stream E-DPDCH power ratio and the secondary stream power offset to determine the number of bits the secondary stream may carry. For instance, the E-DPDCH power ratio may replace the value of the Serving_Grant. As an example for the secondary stream, WTRU 102 may determine the maximum supported payload (e.g., for all the bits including scheduled, non-scheduled, and scheduling information (SI)) based on the following (using the power extrapolation formula as an example):

$$⌊ {K}_{e , ref , m} \cdot \frac{{\sum }_{k = 1}^{{K}_{max}} {( \frac{{β}_{ed , k}}{{β}_{c}} )}^{2}}{{L}_{e , ref , m} \cdot {A}_{ed , m}^{2} \cdot {10}^{Δ harq / 10} \cdot {10}^{Δ offset / 10}} ⌋ , \qquad Equation ( 5 )$$

where the gain factor for E-DPDCH may be calculated from the resulting primary stream TBS using formulas given herein and Δoffset may be signaled by the network. A rank-dependent offset may be used in the calculation of the gain factors.

Equation (5) may be expressed using the virtual secondary stream grant. The virtual secondary stream serving grant (Virtual_SS_SG) may be defined as follows:

$$Virtual\_SS \_SG = \frac{{\sum }_{k = 1}^{{k}_{max}} {( \frac{{β}_{ed , k}}{{β}_{c}} )}^{2}}{{10}^{Δ offset / 10}} , \qquad Equation ( 6 )$$

where the numerator corresponds to the primary stream power ratio (with respect to the DPCCH) and the denominator corresponds to the penalty due to the secondary stream offset signaled by any one of Node-Bs 140ₐ-140_{c}. The number of bits on the secondary stream may be calculated in the extrapolation formulas for example as follows:

$$⌊ {K}_{e , ref , m} \cdot \frac{Virtual\_SS \_SG}{{L}_{e , ref , m} \cdot {A}_{ed , m}^{2} \cdot {10}^{Δ harq / 10}} ⌋ , and \qquad Equation ( 7 )$$

for the interpolation formula as follows:

$$⌊ {K}_{e , ref , m} \cdot \frac{\begin{matrix}( \frac{Virtual\_SS \_SG}{{10}^{Δ harq / 10}} - {L}_{e , ref , m} \cdot {A}_{ed , m}^{2} ) \\ ( {K}_{e , ref , m + 1} - {K}_{e , ref , m} )\end{matrix}}{{L}_{e , ref , m + 1} \cdot {A}_{ed , m + 1}^{2} \cdot {L}_{e , ref , m} \cdot {A}_{ed , m}^{2}} ⌋ . \qquad Equation ( 8 )$$

Note that in the latter the penalty parameter due to the secondary stream offset (Δoffset) is assumed to be expressed in decibel (dB). Equivalently, this parameter could be specified in linear terms (e.g. Offset), leading to an equivalent formulation where we could have the following relationship:

$$offset = {10}^{\frac{Δ offset}{10}} \qquad Equation ( 9 )$$

and equivalently correspond to the following:

$$Virtual\_SS \_SG = {\sum }_{k = 1}^{{k}_{max}} {( \frac{{β}_{ed , k}}{{β}_{c}} )}^{2} \times Offset \qquad Equation ( 10 )$$

This linear form or the decibel form as shown above may be used interchangeably.

Since the maximum number of bits transmitted in E-DCH may depend not only on the power but also on the serving grant, WTRU 102 may determine the maximum supported payload (according to the power headroom), e.g. supported E-TFCIs. WTRU 102 may also determine the remaining scheduled grant payload which indicates the number of bits as supported by the current grant (and HARQ offset), and the total granted payload which indicates the total number of bits allowed by the serving grant and non-scheduled grants for the allowed MAC-d flows.

With respect to E-TFC selection for a secondary stream, WTRU 102 may set the value of maximum number of bits supported to be transmitted by the grant on the secondary stream (e.g. the remaining scheduled grant payload) to the value calculated in equation (5), or the equivalent equation for the extrapolation and interpolation formulas in (7) and (8), respectively. The value calculated by equations (5) or (7)/(8) may also be used by WTRU 102 to determine the set of supported E-TFCIs. In one approach the value of Maximum Supported Payload or maximum supported E-TFCI may be set to the largest E-TFC that is equal to or smaller than the number of bits that can transmitted from a virtual serving grant. Other examples to determining the set of supported E-TFCs are described below.

In an example, if non-scheduled transmissions are allowed on the secondary streams, then the total granted payload for the secondary stream may be equal to the remaining scheduled granted payload as calculated above plus the sum of the applicable non-scheduled grants for the allowed MAC-d flows on the secondary streams. Also, the total granted payload for the secondary stream may be set to the value calculated from equation (6) in equations (7) and (8). If scheduling information (SI) needs to be transmitted, WTRU 102 may take the size of the SI into account in calculating the variables described above.

Since WTRU 102 knows that the secondary stream is supported and also knows the actual transmit power, and since WTRU 102 is configured to transmit with a secondary stream and at this stage WTRU 102 has already determined whether or not the secondary stream may be transmitted according to the power, WTRU 102 may not execute an E-TFC restriction procedure.

In another example, WTRU 102 may be configured to determine the set of supported and blocked E-TFCs for a secondary stream using one or more of the following approaches. In one approach, WTRU 102 may be configured to determine that all E-TFCs are supported for the secondary stream. WTRU 102 may then rely on the virtual secondary stream serving grant to limit the number of bits transmitted on the secondary stream, (i.e. Maximum supported payload). In another approach, WTRU 102 may be configured to determine that all E-TFCs that carry a number of bits smaller than (or smaller than or equal to) the number of bits resulting from the virtual secondary stream serving grant for example as in equations (7) or (8) above are supported. In this approach, WTRU 102 may be configured to calculate the maximum number of bits associated to the virtual secondary stream serving grant, for example by first calculating Virtual_SS_SG in (6) and then using it in combination to equation (7) or (8). WTRU 102 may then determine that all E-TFCs for which the corresponding the number of bits is smaller than or equal to the maximum number of bits associated to the virtual secondary stream serving grant are in supported state for the secondary stream.

If WTRU 102 determines that the selected TBS or the selected E-TFCI for the secondary stream is below a configured threshold, WTRU 102 may be configured to determine that rank-2 is not allowed and fallback to rank-1 transmission.

In another approach, WTRU 102 may be configured to calculate the set of supported E-TFCIs on the secondary stream according to the description herein. WTRU 102 may also calculate the secondary stream TBS independently of the resulting primary stream TBS. In such case, for example, WTRU 102 may determine the secondary stream TBS (or E-TFC) based on headroom and secondary stream offset (and other parameters such as reference power offsets, E-TFCIs, HARQ profile, etc.). In such case, WTRU 102 E-TFC selection for rank-2 transmission may result in two E-TFC (one per stream) needing different gain factors. Since WTRU 102 may be restricted to transmit the E-DPDCH and S-E-DPDCH in UL MIMO at the same power, WTRU 102 may determine the final gain factors used for transmission.

WTRU 102 may use the gain factors resulting from the primary stream E-TFC. It has an advantage of not impacting the open loop power control (OLPC). On the other hand, the margin loop for the secondary stream may be impacted. In that case a serving Node-B may account for this by observing the E-TFCI signaled by WTRU 102. WTRU 102 may also use the gain factor resulting from the secondary stream. In this case the margin loop for the secondary stream may be unaffected but the OLPC may be negatively affected.

WTRU 102 may use the maximum of the two gain factors resulting from the E-TFC selection procedure for both streams. This approach ensures that WTRU 102 transmits with a sufficient power. This may lead to larger variance in OLPC and margin loop. After the E-TFC selection completes for rank-2 transmission, WTRU 102 may determine the gain factor based on the TBS on each stream and the secondary stream offset for the secondary stream. WTRU 102 may then determine the final gain factor to be applied on the E-DPDCH and S-E-DPDCH as follows: if β_{s,ed,k}/β_{c}>β_{p,ed,k},β_{c} then β_{ed,k}/β_{c}=β_{s,ed,k}/β_{c}, otherwise β_{ed,k}/β_{c}=β_{p,ed,k}/β_{c}, where β_{s,ed,k} is the gain factor for the S-E-DPDCH, β_{p,ed,k} is the gain factor for the primary stream E-DPDCH and β_{ed,k} is the final value of the gain factor to be applied to both S-E-DPDCH and E-DPDCH.

In case where the primary stream transmission parameter (TF or TBS) or secondary stream transmission parameter does not allow rank-2 transmission, WTRU 102 may fall back to rank-1 transmission. The case where two new transmissions are requested and WTRU 102 has executed E-TFC selection for the primary stream and then has determined that the conditions for rank-2 transmission are not met is considered.

WTRU 102 may also use a regular or legacy (rank-1) E-TFC selection procedure. In this case, WTRU 102 may stop the rank-2 E-TFC selection procedure and restart the E-TFC selection with a legacy E-TFC selection procedure (rank-1) considering that WTRU 102 transmission parameters may be different for rank-1 and rank-2. A special power offset may be configured for rank-2 transmission which may result in a smaller number of bits for the same transmit power. Additionally, in the power-limited case, the supported set of E-TFCI may change for rank-1 transmission as the available power in WTRU 102 may be fully used for one stream rather than split across the two streams.

WTRU 102 may also continue with the selected primary stream TBS. This applies to the case where WTRU 102's secondary stream does not satisfy the rank-2 transmission parameter needs and WTRU 102 has already selected an E-TFC for the primary stream. WTRU 102 may also use the selected primary stream E-TFC for rank-1 transmission, even if it was selected under a rank-2 transmission assumption, to save WTRU computations and considering that the rank-2 parameters may be more conservative than the rank-1 transmission parameters.

Described herein are methods for WTRU 102 to overrule fallback to rank-1. For example, WTRU 102 may transmit with rank-2 if the selected E-TFCI on the primary stream does not meet the rank-2 transmission needs and if WTRU 102 grant and headroom (the set of supported rank-2 E-TFCI is non-empty) allow it. For example, WTRU 102 may transmit with rank-2 if there is still data available in buffer (e.g., above a threshold) in non-removable memory 130. In such case, WTRU 102 may carry on the secondary stream E-TFCI selection. WTRU 102 may use the lowest supported E-TFCI that can be transmitted using rank-2 and pad, for example, with zeros. In another example, WTRU 102 may determine the E-TFCI on the secondary stream without limitation, and then apply rate matching to ensure that the selected E-TFCI on the secondary stream uses the allowed 2*SF₂+2*SF₄ transport format. WTRU 102 may then perform rank-2 transmission and may perform any of the procedures described herein to equalize the power across the two streams.

In UL MIMO operations, each stream HARQ process may be independent and thus may be positively or negatively acknowledged independently by any one of Node-Bs 140ₐ-140_{c}. As a result, in any given TTI, WTRU 102 may be retransmitting the primary stream, the secondary stream, or both.

When WTRU 102 is retransmitting the primary stream to any one of Node-B's 140ₐ-140_{c}, WTRU 102 may determine whether or not to generate a new TB for the secondary stream. WTRU 102 may determine to generate a new TB when it has sufficient power headroom and data to transmit and when any one of Node-Bs 140ₐ-140_{c} allow rank-2 transmissions. WTRU 102 may also determine whether or not it has sufficient power to transmit with rank-2 by executing the E-TFC restriction procedure assuming rank-2 transmission (e.g. as described above) and determining if the primary stream E-TFCI (the one being retransmitted) is supported or not for rank-2 transmission. If it is supported, then WTRU 102 has sufficient power headroom for rank-2 transmission with the primary stream retransmitting. WTRU 102 may be configured to determine the maximum E-TFC in supported state (i.e. the largest supported E-TFCI) for the primary stream according to the NRPM assuming rank-2 transmission. WTRU 102 may then determine if the maximum E-TFC in supported state is smaller than the primary stream E-TFC (or equivalently the retransmission block size for the primary stream). If it is the case, WTRU 102 may then attempt rank-2 transmission. Otherwise WTRU 102 may transmit the primary stream retransmission only, using rank-1 transmission.

When WTRU 102 is retransmitting the primary stream to any one of Node-B's 140ₐ-140_{c}, WTRU 102 may determine whether or not to generate a new TB for the secondary stream. WTRU 102 may do so when it has sufficient power headroom and data to transmit and when any one of Node-Bs 140ₐ-140_{c} allow rank-2 transmissions. WTRU 102 may also determine whether or not it has sufficient power to transmit with rank-2 by executing the E-TFC restriction procedure assuming rank-2 transmission (e.g. as described above) and determining if the primary stream E-TFCI (the one being retransmitted) is supported or not for rank-2 transmission. If it is supported, then WTRU 102 has sufficient power headroom for rank-2 transmission with the primary stream retransmitting.

More specifically, since the power of the E-DPDCH is known, (due to the retransmission), and the power of the S-E-DPDCH is also known, (as it is equal to the E-DPDCH power), WTRU 102 may determine that no new TB is selected on the secondary stream resulting in rank-1 transmission, (e.g. retransmission on the primary stream), if the power is insufficient for rank-2 transmission. If WTRU 102 determines that it has insufficient power for rank-2 transmission, it may set the NRPM value to zero. WTRU 102 may set the NRPM or the virtual serving grant equal to the primary stream E-DPDCH power ratio, (and account for the offset), if WTRU 102 determines that it has sufficient power.

More specifically, WTRU 102 may determine the following NRPM for the secondary stream:

NRPM_{s,tmp}=(PMax−P_{DPCCH,target}−P_{HS-DPCCH}−P_{E-DPCCH}−P_{S-E-DPCCH}−S-DPCCH−P_{E-DPDCH}))/P_{DPCCH,target} Equation (11)

If NRPM_{s,tmp}<P_{E-DPDCH}/P_{DPCCH}, then WTRU 102 transmits with rank-1 and does not select a new TB for the secondary stream. The NRPMs may be set to zero, (NRPMs=0). Otherwise, if NRPM_{s,tmp}≧P_{E-DPDCH}/P_{DPCCH}, WTRU 102 may transmit with rank-2. NRPMs may be set to NRPMs=P_{E-DPDCH}/P_{DPCCH}. Note that PMax is assumed to be the maximum available power for rank-2 transmission, potentially taking NRPM into account, P_{E-DPCCH}, P_{S-E-DPCCH}, P_{S-DPCCH}, and P_{E-DPDCH} are calculated based on the primary stream E-TFCI.

In another approach, WTRU 102 may determine the NRPM as in (1), and then determine that it has sufficient power for rank-2 transmission if NRPMⱼ/2≧P_{E-DPDCH} for the primary stream E-TFCI j to be retransmitted with the power P_{E-DPDCH}, (the power of the primary stream (E-DPDCH power) being retransmitted). Otherwise, WTRU 102 may determine that it does not have sufficient power for rank-2 transmission.

WTRU 102 may perform E-TFC selection for the second stream according to any of the embodiments described above, where the virtual serving grant may be set according to the resulting primary stream E-DPDCH power ratio and the offset. The NRPM used to determine the set of supported E-TFCs may be determined according to the paragraph above or alternatively the set of supported E-TFCs for the second stream may be determined according to the embodiments described herein.

In addition to verifying for power headroom and data buffer, WTRU 102 may also be configured to determine if the most current value of the serving grant supports rank-2 transmission. This may be due to the fact that a Node-B and/or non-serving Node-Bs issue grant commands independently from WTRU 102 retransmissions. As a result, WTRU 102 may have decreased its serving grant between the moments of the original transmission and the retransmission.

Since the retransmission of the primary stream uses the same gain factor as the original transmission, WTRU 102 knows the power for a rank-2 transmission in this case. WTRU 102 may thus be configured to determine whether or not the most current value of the serving grant allows rank-2 transmission. This may be carried out, for example, by comparing the primary stream power offset, (for the retransmitting E_DPDCH), to the current serving grant. More specifically, if the following is satisfied:

$$SG \geq {\sum }_{k = 1}^{{k}_{max}} {( \frac{{β}_{ed , k}}{{β}_{c}} )}^{2} , \qquad Equation ( 12 )$$

then WTRU 102 may be allowed rank-2 transmission according to the SG.

WTRU 102 may also be configured to determine if the current SG is large enough to allow for rank-2 transmissions. More specifically, WTRU 102 may be configured to compare the current SG to a threshold associated to the minimum TB for rank-2 transmission. If the SG is above the minimum SG for rank-2 threshold, WTRU 102 may be configured to consider rank-2 transmissions; otherwise WTRU 102 may be configured to not allow rank-2 transmission and perform a rank-1 retransmission in the primary stream.

WTRU 102 may also calculate the maximum number of bits allowed by the SG and then compare it to the minimum TB configured for rank-2 transmission. More specifically, WTRU 102 may be configured to determine the maximum number of bits allowed by the SG using equations (7) or (8) depending on configuration with Virtual_SS_SG replaced by SG. In calculating the number of bits allowed by the SG, WTRU 102 may determine the HARQ offset (i.e. Aharq in (7) and (8)) from the same HARQ profile used to calculate the number of bits than the HARQ profile used for the retransmission or WTRU 102 may use the HARQ offset from the HARQ profile of the highest priority data that can be transmitted in that TTI. If WTRU 102 determines that the SG allows at least as many bits as the minimum TB for rank-2 transmission, WTRU 102 may allow rank-2 transmission. Otherwise WTRU 102 may be configured to transmit with rank-1. Note that this approach may be executed also when WTRU 102 has two new transmissions and when WTRU 102 has just one retransmission on the secondary stream. Further, WTRU 102 may determine this before executing E-TFC restriction/E-TFC selection to avoid doing unnecessary calculations thereby draining battery.

Similarly, as described for the two transmission case, WTRU 102 may also avoid second stream E-TFC selection by checking in advance if the number of bits that can multiplexed together in the secondary stream for the given TTI is above the minimum TB size for rank-2 transmission threshold. If the number of bits is lower, than WTRU 102 determines that rank-2 is not supported. WTRU 102 may use this information to determine that it shouldn't perform E-TFC selection/restriction for rank-2 transmissions. Otherwise, WTRU 102 may perform rank-2 E-TFC selection and/or determine if the grant and or power limitation criteria are met. It is understood that this may also be performed for the case where the secondary stream is retransmitting and the HARQ entity of the primary stream of WTRU 102 has invoked a new transmission.

It is understood that the criteria described above for power limitation, grant limitation, or buffer limitation may be done in any order and in any combination. If any of the three criteria is not met, WTRU 102 may fall back to rank-1 transmissions.

In another example, WTRU 102 may perform an E-TFC selection for the primary stream and determine a theoretical E-TFC as if a new transmission was taking place. The NRPM, (e.g. available power), number of bits based on SG, and buffer are taken into account as described above. If the theoretical resulting E-TFC is less than the minimum TB for rank-2 transmission, WTRU 102 may fall back to rank-1 transmission.

In cases where WTRU 102 is not allowed to transmit with rank-2 according to power headroom, SG, or buffer, WTRU 102 may be configured to not generate a TB for the secondary stream and WTRU 102 may retransmit with rank-1.

If WTRU 102 determines that rank-2 transmission is allowed, WTRU 102 may execute E-TFC selection as in the two new retransmission cases for the secondary stream, for example as described herein. If the final E-TFCI of the second stream results in a value smaller than the minimum TB size for rank-2 transmission, WTRU 102 may just perform rank-1 transmission and retransmits the data in the primary stream.

Secondary stream retransmission may also be performed by WTRU 102. In this case, WTRU 102 is retransmitting the secondary stream but not the primary stream. WTRU 102 may be configured to generate a new transmission on the primary stream if it is allowed rank-2 transmission, has sufficient power to transmit, and has data in its buffer. Otherwise, WTRU 102 may be configured to transmit with rank-1 (e.g., switching the secondary stream to the primary stream pre-coding vector).

When WTRU 102 selects a much different TB on the primary stream than the previous TBS, this may result in a power imbalance between the primary and secondary stream. Since the E-DPDCH and S-E-DPDCH powers may be equal, WTRU 102 may tradeoff data rate, efficiency, and reliability.

Table 1 summarizes the different cases for the power resulting from E-TFC selection for the primary stream. In the first case, the primary stream may be forced to equal the secondary stream power. This imposes an undesirable data rate limit on the primary stream and in some case WTRU 102 may be buffer-limited and it may not be able to support that rate. In case where the resulting primary stream power is smaller than the secondary stream power, as shown in Table 1, WTRU 102 may scale down the secondary stream power leading to a reduction in reliability, or scale up the primary stream leading to waste of power efficiency. In case where the resulting primary stream power is larger than the secondary stream power, WTRU 102 may be configured to scale up the secondary stream power leading to lower secondary stream inefficiency.

TABLE 1

| Primary Stream | | |
|---|---|---|
| Power with | | |
| respect to | | |
| Secondary | | |
| Stream Power | Power Scaling Action | Comment |
| Equal (forced) | Not needed | This may impose a limit on |
| | | primary stream. |
| Smaller | Scale down secondary | May decrease secondary |
| | stream power | stream reliability at the |
| | | expense of primary stream |
| | | efficiency |
| | Scale up primary | May decrease primary stream |
| | stream power | efficiency at the expense of |
| | | secondary stream reliability |
| Larger | Scale up secondary to | May decrease secondary |
| | match | stream efficiency |

When WTRU 102 is retransmitting on the secondary stream, WTRU 102 may be configured to transmit a new TB on the primary stream if it has sufficient power to do so. WTRU 102 may thus be configured to determine if it has sufficient power for rank-2 transmission, and may determine the NRPM for the primary stream.

In a first approach to determine if WTRU 102 has sufficient power to transmit with rank-2, WTRU 102 may be configured to determine the minimum power for the retransmitting secondary stream, (or equivalently, the P_{S-E-DPDCH,min}). WTRU 102 may determine the minimum power for the retransmitting secondary stream, using one or more of the following:
1) P_{S-E-DPDCH,min} is the power of the S-E-DPDCH used in the last transmission of the same HARQ process;
2) P_{S-E-DPDCH,min} is the power of the S-E-DPDCH used in the original transmission of that transport block; or
3) P_{S-E-DPDCH,min} is calculated using the interpolation or extrapolation formula, using the TBS value, the most current value of the secondary stream offset as well as the HARQ offset. In one example, WTRU 102 calculates the gain factor using equation (2), (or the equivalent form for the interpolation formula), and may further determine the transmit power using the most recent estimate of the DPCCH power.

WTRU 102 may then determine if it has sufficient power for a rank-2 transmission by determining the NRPM for the primary stream and comparing it to the minimum power ratio for dual-stream transmission with the secondary stream retransmitting. For example, WTRU 102 may determine the NRPM as in equation (1).

WTRU 102 may then determine if it has sufficient power to transmit with dual-stream by comparing the resulting NRPM with the minimum power ratio. More specifically, WTRU 102 may determine that if NRPMⱼ/2<P_{S-E-DPDCH,min}/P_{DPCCH}, WTRU 102 has no sufficient power to transmit with dual-stream and the resulting NRPM for the primary stream may be set to NRPMp=0. Otherwise, if NRPMj/2≧P_{S-E-DPDCH,min}/P_{DPCCH}, WTRU 102 may determine that it has sufficient power to transmit with rank-2 transmission and use the calculated NRPM for the purpose of E-TFC restriction.

WTRU 102 may be configured to execute E-TFC selection on the primary stream assuming rank-2 transmission, without consideration for the secondary stream retransmission. Once the primary stream E-TFCI and associated gain factors (and thus power) are determined, WTRU 102 determine whether or not rank-2 transmission may take place. For example, WTRU 102 may compare the resulting primary stream E-TFCI to a threshold, (for example a minimum E-TFCI that for example corresponds to a minimum TB, or to the secondary stream E-TFCI), or determine the associated transport format and determine whether or not it is 2*SF₂+2*SF₄. If the resulting primary stream E-TFCI is below the threshold or if the transport format is not 2*SF₂+2*SF₄, WTRU 102 may retransmit with rank-1 on the primary stream.

In cases where WTRU 102 determines that the transmission should be rank-2, WTRU 102 may further determine the secondary stream transmission power. WTRU 102 may set the power of the secondary stream to the power of the newly selected primary stream. WTRU 102 may also first determine whether or not the newly calculated primary stream power is sufficient for the secondary stream, and if not, WTRU 102 may set the power of the primary stream and secondary stream to the minimum power needed by the secondary stream. For example, this may be achieved by calculating the needed power for the secondary stream, using the most recent value of the secondary stream offset. Since the secondary stream TBS and HARQ offset are known, WTRU 102 may determine the needed gain factor/power, for example, using the extrapolation or interpolation formula with the secondary stream offset (e.g., as in equation (2)). WTRU 102 may be configured to set the E-DPDCH and S-E-DPDCH transmit power to the largest of the primary and secondary stream power.

In a second method, WTRU 102 may be configured to execute E-TFC selection on the primary stream assuming rank-2 transmission, having first determined that it has sufficient power, (e.g. using NRPM), to transmit with rank-2.

In order to save on processing time and power, WTRU 102 may be configured to determine at various steps in the E-TFC selection procedure whether or not rank-2 should be allowed. In an example, WTRU 102 may be configured to calculate the set of supported E-TFCs for the primary stream, (e.g. using the methods described herein), for example assuming rank-2 transmission but without considerations for the secondary stream retransmissions. WTRU 102 may then determine that rank-2 transmission is not allowed and retransmits with rank-1 on the primary stream if one or more of the following criteria are met:
1) WTRU 102 determines that the maximum supported E-TFCI for the primary stream is below a minimum value, (e.g. corresponding to a minimum TBS, minimum E-TFCI);
2) WTRU 102 determines that the maximum supported E-TFCI for the primary stream is below the E-TFCI of the secondary stream (being retransmitted); or
3) WTRU 102 determines that the maximum supported E-TFCI for the primary stream is below the E-TFCI of the secondary stream (being retransmitted) by a certain threshold.

In another example, WTRU 102 may be configured to calculate the maximum transport block size according to a serving grant. WTRU 102 may then determine that rank-2 transmission is not allowed and retransmits with rank-1 on the primary stream if one or more of the following criteria are met:
1) WTRU 102 determines that the maximum transport block size according to the serving grant for the primary stream is below a minimum value, (e.g. corresponding to a minimum TBS, minimum E-TFCI);
2) WTRU 102 determines that the maximum transport block size according to the serving grant for the primary stream is below the transport block size of the secondary stream (being retransmitted);
3) WTRU 102 determines that the maximum TB size according to the SG and the sum of the non-scheduled MAC-d flows that can be transmitted in the given TTI is below a minimum TB for rank-2 transmission; or
4) WTRU 102 determines that the maximum TB size according to the SG and the sum of the non-scheduled MAC-d flows that can be transmitted in the given TTI is below the transport block size of the secondary stream (being retransmitted).

WTRU 102 may also be configured to take into account not only the maximum number of bits according to the serving grant but also the maximum number of bits for non-scheduled transmissions.

In another example, WTRU 102 may be configured to calculate the set of supported E-TFCI on a secondary stream, for example taking into account the most recent value of the offset, and determine whether or not the retransmitted E-TFCI is supported in the current transmission. This may be achieved for example using the following approach.

WTRU 102 may calculate the NRPM using equation (1). WTRU 102 may then determine the set of supported E-TFCIs for the secondary stream, for example as follows: the set of supported E-TFCIs for the secondary stream assuming rank-2 transmission may be determined (for the non-compressed frame case) such that if NRPMᵢ≧2Σ(β′_{ed,j}/β_{c})² then E-TFCⱼ can be supported on the secondary stream with rank-2 transmission, otherwise it may not be supported on the secondary stream with rank-2 transmission. The gain factor β′_{ed,j} for an S-E-DPDCH may be calculated for example by taking into considerations the secondary stream offset as in equation (2) for the extrapolation formula, (similar concept applies for the interpolation formula). WTRU 102 then determines whether the retransmitting E-TFC on the secondary stream is supported.

If WTRU 102 determines that the retransmitting E-TFC on the secondary stream is not supported, WTRU 102 may be configured to retransmit using rank-1. This operation may be similar to WTRU 102 transmitting the secondary stream on the primary stream. Otherwise WTRU 102 may be configured to continue the E-TFC selection procedure for rank-2 transmission with secondary stream retransmission.

In another approach, WTRU 102 may perform E-TFC selection for the primary stream assuming rank-2 transmission is possible and taking account the available power, serving grant, non-scheduled grants, and buffer status. If the selected E-TFCI for the primary stream is below the minimum TB size for rank-2 transmission, WTRU 102 may fall back to rank-1 transmission (e.g. retransmits the data in the secondary stream over the primary stream).

Described hereforth are examples to determine the secondary stream transmit power and a-posteriori transmission rank. For example, this may be achieved by calculating the needed power for the secondary stream, using the most recent value of the secondary stream offset. Since the secondary stream TBS and HARQ offset are known, WTRU 102 may determine the gain factor/power using the extrapolation or interpolation formula with the secondary stream offset (e.g., as in equation (2)). WTRU 102 may be configured to set the E-DPDCH and S-E-DPDCH transmit power to the largest of the primary and secondary stream power.

In case the selected transmit power exceeds the maximum headroom, WTRU 102 may further apply power scaling to ensure that the maximum power limit is not exceeded. WTRU 102 may also be configured to transmit with rank-1 when the resulting primary stream power is lower than the transmit power for the secondary stream. In such a scenario, WTRU 102 may fallback to rank-1 because of power-limitation. WTRU 102 may thus retransmit the secondary stream on the primary stream.

Moreover, WTRU 102 may be configured to determine the set of supported E-TFCs for the secondary stream. In one example, the set of supported E-TFCs may be calculated using the latest available secondary stream offset. WTRU 102 may then determine whether the retransmitting secondary stream E-TFC is supported or not. In the case where the retransmitting secondary stream E-TFC is not supported, WTRU 102 may fallback to rank-1 transmission because of power-limitation. WTRU 102 may thus in that case retransmit the secondary stream on the primary stream.

WTRU 102 may also treat non-scheduled transmissions as scheduled transmissions an E-TFC selection procedure. WTRU 102 may also be configured with a number of bits for non-scheduled transmissions. For UL MIMO operations, WTRU 102 may be configured with a number of bits for non-scheduled transmission. WTRU 102 may also be configured with a single total number of bits for non-scheduled transmission, which is aggregated across both streams. WTRU 102 may also be configured with a per-stream number of non-scheduled bits.

In the case where WTRU 102 may be configured with a single pool of non-scheduled bits, WTRU 102 may transmit this total of non-scheduled bits across both streams. When performing E-TFC selection for the secondary stream, WTRU 102 may use the remaining non-scheduled bits from the primary stream as maximum number of non-scheduled bits for the secondary stream. Alternatively, WTRU 102 may transmit non-scheduled transmissions just on the primary stream.

In release 9 dual cell HSUPA (DC-HSUPA), non-scheduled transmissions may be transmitted primarily over the primary uplink frequency. A reason for this was that noise and interference management in the UL may be independent on each frequency. In order for any one of Node-Bs 140a-140, to properly pre-allocate non-scheduled grants and be prepared for potential noise rise on each carrier a Node-B may have to reserve resources twice in order to account for potential non-scheduled transmission on any of the frequencies. Therefore, in order to overcome this possible inefficiency it was decided to restrict non-scheduled transmissions to the primary carrier.

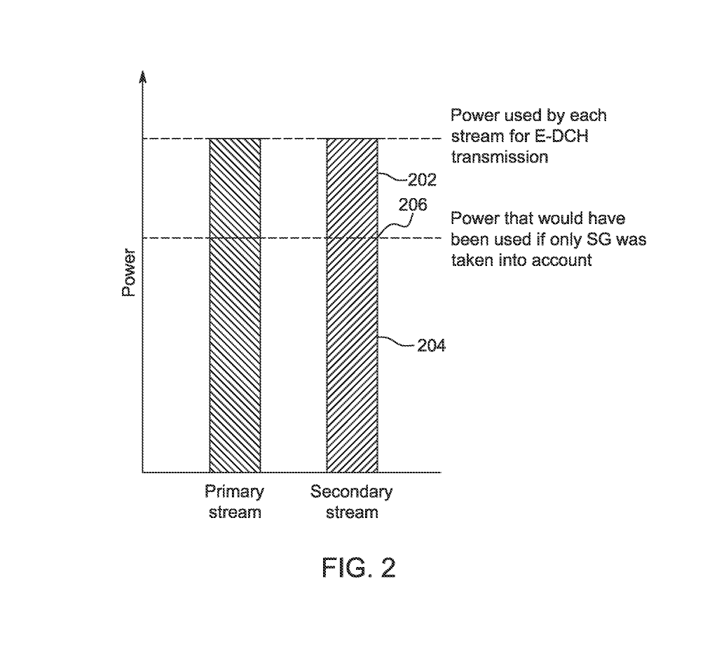

However, for UL MIMO the undesirable scenario may be slightly different due to the fact that the power used on both streams may be equal. When the primary stream is filled up, if enough power headroom is available, WTRU 102 may include both non-scheduled data (up to the non-scheduled grant) and scheduled data (up to the signaled serving grant). The power on the secondary stream may be equal to the primary stream power which may result in WTRU 102 transmitting more power than just the serving grant alone would have allowed. This is illustrated in FIG. 2. FIG. 2 shows a non-scheduled grant impact on transmitted power. The non-scheduled grant power 202 may increase the secondary stream transmission power 204 above what the SG would allow (206).

The undesirable scenario described above may occur whether or not transmission of non-scheduled data may be restricted on the primary stream. Communications system 100 may assume that WTRU 102 may end up transmitting with a power of up to SG+non-serving grant (NSG) in both streams, thereby reserving twice the desired amount in its noise rise budget. The described undesirable scenario may be resolved or mitigated using one or more of the following examples, which may be used in any combination.

WTRU 102 may be configured to use up to half its non-scheduled grant on the primary stream and up to half its non-scheduled grant on the secondary stream when performing rank-2 transmission for each of an allowed MAC-d flow. WTRU 102 may use half its non-scheduled grant on the primary stream, WTRU 102 may transmit in total the additional amount determined by the non-scheduled grant.

WTRU 102 may also be configured to use up to half its non-scheduled grant on the primary stream, and any remaining amount of non-scheduled grant on the secondary stream (up to the full non-scheduled grant for the corresponding MAC-d flow) when performing a rank-2 transmission to any one of Node-Bs 140ₐ-140_{c}. TRU 102 may not transmit non-scheduled transmission on the primary stream (e.g., due to the priority list) yet it may have lower-priority non-scheduled data to transmit on the secondary stream during the same TTI. When there is high-priority non-scheduled data WTRU 102 may limit the grant in such a way as to ensure that it does not transmit with too much power (i.e., by limiting the non-scheduled grant to half of the total non-scheduled grant) on the primary stream.

WTRU 102 may be configured for rank-2 transmission on a HARQ-process basis. Some HARQ processes may be configured for dual-stream operations whereas the other HARQ processes may be either deactivated or configured for legacy rank-1 transmission. WTRU 102 may be further configured with no non-scheduled grant for the HARQ processes configured for dual-stream operations.

In addition, WTRU 102 may be configured to not use non-scheduled grant with dual-stream transmission. In such cases, WTRU 102 may use the scheduled grant to transmit non-scheduled data during those rank-2 transmissions where non-scheduled grant may not be used.

A WTRU may also calculate the effective serving grant for the secondary and/or primary stream based as a function of the available power. If the available power is not sufficient for WTRU 102 to transmit up to the configured serving grant, WTRU 102 may scale the grant of the primary stream or the secondary stream.

In addition, for the case where the non-scheduled transmissions are not taken into account and for the case where the non-scheduled transmissions are taken into account is also a consideration. Non-scheduled transmissions may not use a scheduled grant. Instead, WTRU 102 may be configured to use a non-scheduled grant configured by the network. Since the non-scheduled transmission does not use the scheduled grant and they may be present (if configured) in any given transmission, WTRU 102 may take the non-scheduled transmission into account when scaling the SG in order to ensure that WTRU 102 is not transmitting above the power limit due to the non-scheduled transmissions.

WTRU 102 may also determine the effective serving grant for the primary and/or secondary streams without taking into account the non-scheduled transmissions. This may applicable for example if it is determined that the non-scheduled transmissions do not have a significant impact to the transmission power, if WTRU 102's buffer does not contain non-scheduled data, if the transmission is not allowed or configured for non-scheduled transmission, or if WTRU 102 is not configured to transmit non-scheduled data.

WTRU 102 may apply scaling to the SG when power-limited. When referring to a WTRU being “power-limited”, it makes reference to rank-2 power limitation and may be equivalent to a WTRU being “rank-2 power-limited.” WTRU 102 may be power-limited when it is unable to fulfill its serving grant with its current power headroom. For instance, WTRU 102 may determine if it is power-limited by comparing the maximum payload (the number of bits) supported based on the headroom and the maximum payload supported based on the serving grant. More specifically, WTRU 102 may determine the maximum rank-2 supported E-TFC on the primary stream and on the secondary stream, for instance based on the examples disclosed above, and determine the maximum number of bits supported with the SG by adding the maximum number of bits supported for each stream, and determine the number of bits supported by the SG for the primary stream and for the secondary stream (based on equation (4)). WTRU 102 may then compare the results and may determine that it is power-limited if the maximum payload based on the headroom is smaller than the maximum payload based on a current SG.

In another example, WTRU 102 may determine whether it is rank-2 power-limited by comparing the NRPM directly with the SG. For example, if the NRPM is smaller than twice the SG (or the SG if the SG indicates the total serving grant), WTRU 102 may determine that it is power-limited; otherwise WTRU 102 may determine that it is grant-limited. WTRU 102 may use the NRPM as calculated in equation (1).

If WTRU 102 determines that it is rank-2 power-limited, WTRU 102 may scale a serving grant. WTRU 102 may determine the scaling factor in such a way as to ensure that WTRU 102 is no longer power-limited after application of the scaling factor to the SG. For example, WTRU 102 may determine a scaling factor (α) as follows:

$$α = \frac{NRPM}{2 \cdot SG} . \qquad Equation ( 13 )$$

WTRU 102 may then apply the scaling factor to the serving grant. The scaled serving grant for the primary stream may be expressed as follows (in the linear domain):

SG_{p,scaled}=αSG. Equation (14)

The resulting virtual secondary stream serving grant may be expressed as follows (in the linear domain):

SG_{s,scaled}=αSG/Δoffset=SG_{p,scaled}/Δoffset, Equation (15)

where Δoffset is the offset applied to the secondary stream as signaled by the network (in the linear domain). Note that similar equations or expressions may be derived in the log or decibel domain.

For the secondary stream, WTRU 102 may not scale the serving grant but rather use the actual selected transmit power on the primary stream to determine the virtual grant, for example as follows:

$${SG}_{s} = \frac{{\sum }_{k = 1}^{{K}_{max}} {( \frac{{β}_{ed , k}}{{β}_{c}} )}^{2}}{{10}^{\frac{Δ offset}{10}}} \qquad Equation ( 16 )$$

where the E-DPDCH gain factors may be determined based on the selected TBS on a primary stream.

WTRU 102 may determine the effective serving grant for the primary and/or secondary stream taking into account non-scheduled transmissions. This may be applicable if it is determined that non-scheduled transmissions have a substantial impact to the transmission power, if WTRU 102 buffer contains non-scheduled data, if the transmission is allowed or configured for non-scheduled transmissions, or if WTRU 102 is configured to transmit non-scheduled data.

WTRU 102 may be configured to apply scaling to the SG when power-limited. WTRU 102 may be power-limited when with its current power headroom it is unable to fulfill its serving grant in addition to the non-scheduled grant, i.e., the total grant. WTRU 102 may determine if it is power-limited for example by comparing the maximum payload (the number of bits) supported based on the headroom and the maximum payload supported based on the total of serving and non-scheduled grant. More specifically, WTRU 102 may determine the maximum rank-2 supported E-TFC on a primary stream and on a secondary stream. WTRU 102 may further determine the maximum number of bits supported with the SG by adding the maximum number of bits supported for each stream and the total non-scheduled grant.

Moreover, WTRU 102 may determine the number of bits supported by the total grant for the primary stream and for the secondary stream (such as based on equation (4)) and then add the non-scheduled grant configured by the network (the non-scheduled grant may be expressed as a number of bits). WTRU 102 may then compare the results for the headroom and total grant and may determine that it is power-limited if the maximum payload based on the headroom is smaller than the maximum payload based on the total grant.

In another example, WTRU 102 may determine whether it is rank-2 power-limited by comparing the NRPM directly with the total grant (expressed in power ratio). For example, if the NRPM is smaller than twice the total grant, WTRU 102 may determine that it is power-limited. Otherwise WTRU 102 may determine that it is grant-limited. WTRU 102 may determine the total grant expressed in power ratio for example by calculating the power used for non-scheduled grant (Pnon-sg). WTRU 102 may then determine the total grant as the sum of the SG and the non-scheduled grant power ratio (NSG), which may be defined for example as NSG=Pnon-sg/P_{DPCCH}, where Pnon-sg is the estimated power for the non-scheduled grant.

If WTRU 102 determines that it is rank-2 power-limited, WTRU 102 may scale the SG. WTRU 102 may determine the scaling factor in such a way as to ensure that WTRU 102 is no longer power-limited (considering the non-scheduled grant) after application of the scaling factor to the SG, that is:

2(SG+NSG)≦NRPM. Equation (17)

WTRU 102 may determine a scaling factor (α) as follows:

$$α = \frac{( \frac{NRPM}{2} - NSG )}{SG} . \qquad Equation ( 18 )$$

WTRU 102 may then apply the scaling factor to the serving grant. The scaled serving grant for the primary stream may be expressed as follows (in the linear domain):

SG_{p,scaled}=αSG. Equation (19)

The resulting virtual secondary stream serving grant may be expressed as follows (in the linear domain):

SG_{s,scaled}=αSG/Δoffset=SG_{p,scaled}/Δoffset, Equation (20)

where Δoffset is the offset applied to the secondary stream as signaled by the network (in the linear domain). It should be noted that similar equations or expressions may be derived in the log or decibel domain.

WTRU 102 may determine an effective serving grant for the primary and secondary streams. This effective serving grant may take into account not only the grant for scheduled transmissions but also the grant for non-scheduled transmission. In such cases, the effective grant for the primary and secondary stream may be expressed as follows (in the linear domain):

SG_{p,eff}=αSG+NSG, Equation (21)

SG_{s,eff}=αSG/Δoffset+NSG. Equation (22)

WTRU 102 may determine that it can support rank-2 transmissions if the following criteria is satisfied: the maximum allowed TBS related to a serving grant and non-scheduled data on the primary stream and/or secondary stream is greater than or equal to the minimum allowed dual stream TBS, the maximum supported E-TFCI related to available power for rank-2 transmission on the primary stream or on both streams is greater than or equal to the minimum allowed dual stream TBS, and the total number of bits that can be transmitted on both streams is greater than or equal to the minimum allowed dual stream TBS.

The minimum allowed dual stream TBS may be configurable by the network via RRC messaging from any one of Node-Bs 140ₐ-140_{c} and/or may be determined by WTRU 102 (e.g., a WTRU determines the value based on the first E-TFCI that can be transmitted using 2*SF₂+2*SF₄).

In order to determine if dual stream transmission is supported based on the number of bits that may be transmitted according to the allowed grant, WTRU 102 may determine the number of bits that may be transmitted assuming dual stream on the primary stream with a given grant. More specifically, WTRU 102 may support dual stream transmissions if one or a combination of the following criteria is met:
the total number of bits allowed to be transmitted based on the SG of the primary stream (taking into account the HARQ profile of the highest priority MAC-d flow) is greater than or equal to the minimum allowed dual stream TBS;
the total number of scheduled bits allowed to be transmitted related to a SG and the total number of non-scheduled bits allowed to be transmitted based on the non-scheduled grants for the MAC-d flows allowed to be multiplexed in the given TTI is greater than or equal to the minimum allowed dual stream TBS (alternatively, half the number of total non-scheduled bits allowed may be considered);
the value of SG is greater than or equal to a configured or pre-determined power threshold; or
the value of SG+Pnon-sg greater than or equal to a configured or pre-determined threshold.

WTRU 102 may determine whether the minimum allowed dual stream TBS criteria is met on the secondary stream based on the virtual serving grant on the second stream. The virtual serving grant may be determined based on the methods or configurations described above. More specifically, WTRU 102 may select dual stream if the following is met on the second stream:
the total number of bits allowed to be transmitted on the secondary stream based on the second stream or virtual grant value is greater than or equal to the minimum allowed dual stream TBS;
the value of secondary stream SG or virtual serving grant is greater than or equal to a configured threshold(s); or
the number of non-scheduled bits+scheduled bits is above the minimum allowed dual stream TBS, wherein non-scheduled bits may correspond to half the amount of total non-scheduled bits allowed to be transmitted based on non-scheduled grant for the MAC-d flows allowed to be multiplexed in the given TTI, the full amount of non-scheduled bits, or the number of non-scheduled bits configured to be transmitted on the primary stream.

Dual stream transmissions based on a grant may be determined if the minimum allowed dual stream TBS criteria is met in both streams. For example, the criteria may be checked just for the primary stream or WTRU 102 may perform the check just for the secondary stream. If the minimum allowed dual stream TBS is met for the secondary stream, the dual stream operation may be supported for the given TTI based on a grant.

In order to determine if dual stream operation is supported based on available power, WTRU 102 may determine the set of supported E-TFCIs for the primary stream (if dual stream operation is assumed) and for the secondary stream. WTRU 102 may then determine if dual stream is supported in the primary stream, in the secondary stream, or both if one or both of the following criteria is met:
the maximum supported E-TFCI on the primary stream is greater than or equal to the minimum allowed dual stream TBS; or
the maximum supported E-TFCI on the secondary stream is greater than or equal to the minimum allowed dual stream TBS.

WTRU 102 may determine that dual stream transmission is supported if the total number of scheduled bits allowed to be transmitted and multiplexed in the given TTI+the total number of non-scheduled bits up to the allowed non-scheduled grants for the allowed MAC-d flows is greater than twice the minimum allowed dual stream TBS.

In addition, WTRU 102 may first determine if dual stream is supported according to the serving grant. If dual stream is supported, WTRU 102 may then perform dual stream E-TFC restriction procedure as described above. Otherwise WTRU 102 may perform single stream E-TFC restriction and E-TFC selection. If, according to E-TFC restriction, WTRU 102 supports dual stream, WTRU 102 may proceed with dual stream E-TFC selection. It is understood that the steps above may be done in any order.

In another example, WTRU 102 may calculate a set of supported E-TFCIs in parallel assuming single and dual stream transmissions and provide these inputs to the E-TFC selection function. WTRU 102 may determine the number of bits supported based on grants on the primary and/or the secondary stream. WTRU 102 may then determine if dual stream or single stream E-TFC selection should be performed if the criteria on the total grant and supported E-TFCI for dual stream transmission as described above are met.

If dual stream is determined to be supported WTRU 102 may initially fill up the primary stream up to the minimum of the allowed supported E-TFCI for the primary stream (based on dual stream E-TFC restriction), the total granted payload, which may include the number of bits that can be transmitted on the first stream assuming rank 2 according to the serving grant and the sum of non-scheduled grants for the allowed non-scheduled MAC-d flows, and the available number of bits for the allowed MAC-d flows.

If a final E-TFCI selected for the primary stream is above to or equal to the minimum allowed dual stream TBS WTRU 102 may proceed to fill up the secondary stream transport block and perform E-TFC selection for the secondary stream.

WTRU 102 may re-determine the highest priority MAC-d flow and the multiplexing list or use the same as the one determined for the primary stream. WTRU 102 may also fill up the secondary stream based on the minimum of:
the supported E-TFCI for the secondary stream;
the granted payload (e.g., the number of bits allowed on the second stream based on the virtual serving grant and may consider any leftover non-scheduled grant (that was not fully used up on the primary stream; and
the available remaining buffer of the allowed MAC-d flows.

In addition, WTRU 102 may fill up the secondary stream according to the MAC-d flow priorities up to the minimum of: the maximum allowed number of bits determined by calculating allowed number of bits on the secondary stream using the power needed to transmit the selected E-TFCI in the first stream as determined by equation (5). In this case, the maximum allowed payload (e.g. maximum supported payload), and the granted payload may be set to the value calculated in equation (5). It is understood that the number of bits that can be transmitted on the secondary stream may be determined based on final transmission power needed to transmit the primary stream E-TFCI), and the available remaining buffer of the allowed MAC-d flows. If non-scheduled transmissions are allowed and available on the secondary stream, WTRU 102 may use as much non-scheduled bits as allowed by the non-scheduled grant for that MAC-d flow (that is not already used in the primary stream) then move on to the next highest priority MAC-d flow to fill up the remaining space in the secondary stream TB.

If the selected E-TFCI for the secondary stream is above the minimum allowed dual stream TBS WTRU 102 may determine the final transmission power for both stream and transmit the data.

In case where the selected E-TFCI for the secondary stream is lower than the minimum allowed dual stream TBS, WTRU 102 may fall back to single stream transmission. In this case, WTRU 102 may perform one or a combination of the following. WTRU 102 may transmit the transport block and select an E-TFCI in the primary stream as determined when dual stream was assumed (e.g., E-TFC selection is not performed again assuming single stream). Alternatively, WTRU 102 may re-determine the E-TFCI or transport block for single stream transmission. WTRU 102 may determine the new maximum allowed number of bits for single stream based on the SG (if reference E-TFCIs are different).

Moreover, WTRU 102 may calculate the value at the beginning of the procedure (e.g., WTRU 102 calculates both rank-1 and rank-2 maximum number of bits on a primary stream). WTRU 102 may determine the new set of supported E-TFCIs for single stream transmission as described above. WTRU 102 may also calculate the set of supported E-TFCIs in the first stream for both rank-1 and rank-2 at the beginning of the procedure.

WTRU 102 may fill up the transport block up to the new maximum number of bits allowed for single stream transmission and supported E-TFCI for single stream transmission and available buffer. WTRU 102 may be allowed to pad up to a certain amount of bits if the transport block on at least one of the streams is below the minimum allowed dual stream E-TFCI but above a certain allowed E-TFCI (to allow up to some level of padding).

WTRU 102 may determine a secondary stream offset based on a signal transmitted from communications system 100. In one example, the secondary stream offset may be signaled as an index offset to the serving grant. As a result, WTRU 102 may determine the actual virtual serving grant for the secondary stream by finding the entry in the serving grant table that corresponds to the entry of the current serving grant (the baseline) and decrease it by a number of entries in the table corresponding to the index received. In one example, the baseline may be the current serving grant. WTRU 102 may use the latest value of the absolute grant as baseline (thereby ignoring any relative grants). WTRU 102 may also use the most current value of the serving grant ignoring any non-serving relative grant that may have been received since the latest absolute grant was received.

WTRU 102 may also determine the actual Δoffset by comparing the resulting virtual grant for the secondary stream to the SG signaled. For example, WTRU 102 may calculate the virtual grant as described above and then compute the Δoffset as follows (in the linear domain):

Δoffset=SG/(Virtual SG) Equation (23)

Δoffset may also be signaled via an index by the network.

In single stream E-DCH, the happy bit may be transmitted on the E-DPCCH with every E-DPDCH transmission. The happy bit may be used to indicate to the network whether WTRU 102 may use a higher grant (e.g., whether it is happy with the current given grant or not given the available power, currently used grant, and available data) to improve its data rate. The happy bit may take two values: “Happy” if WTRU 102 is satisfied with its current grant, or “Unhappy” if it is not.

WTRU 102 may indicate it is unhappy if in the current transmission it has used all the serving grant, it has enough power to transmit at a higher data rate, and it may not empty its buffer within a Happy bit delay condition ms given the current grant and number of active processes. If any of the above criteria is not met, WTRU 102 may indicate “happy.”

With a rank-2 transmissions two E-DPCCHs will be transmitted (the E-DPCCH and S-E-DPCCH), indicating the transmission parameters for the primary and secondary stream, respectively. As the S-E-DPCCH also carries a happy bit, there are two happy bits available in rank-2 transmission.

Conditions may exist to set the happy bit of each control channel in the context of UL MIMO operations. For WTRUs transmitting with rank-2, the happy bit at least on one stream is set such that it would indicate to the network whether WTRU 102 is happy or unhappy with the current rank-2 transmissions grant.

For dual cell HSUPA (DC-HSUPA), WTRU 102 may check the happy bit condition for each frequency individually. In addition, the grants and power may be individually controlled DC-HSUPA. However, in UL MIMO, there is one SG signaled on the primary cell and both streams are transmitted at equal powers. Further, the rate on the secondary stream may be determined by the channel conditions.

When transmitting the S-E-DPDCH (rank-2), WTRU 102 may be configured to transmit the associated S-E-DPCCH. The S-E-DPCCH may have the same format as the E-DPCCH and may carry a happy bit. This field will be referred to as the secondary happy bit. WTRU 102 may set the value of the secondary happy bit to the same value as the happy bit on the E-DPCCH. Setting the happy bit on the E-DPCCH and S-E-DPCCH, and setting the happy bit on a specific control channel (i.e., E-DPCCH or S-E-DPCCH) may be equally applicable to the other control channel.

Examples for calculating the happy bit for rank-2 happiness indication are disclosed hereafter (i.e., whether or not WTRU 102 is satisfied with the current serving grant in rank-2 condition). These new conditions may also apply when WTRU 102 is configured with UL MIMO and does not transmit with rank-2 (e.g., WTRU 102 is buffer-limited, any one of Node-Bs 140ₐ-140_{c} may restrict transmission to rank-1 in the upcoming TTI, etc.).

For the first criterion, WTRU 102 may be configured to check if it is transmitting as much scheduled data as allowed by the SG. Since, WTRU 102 is transmitting on two streams WTRU 102 checks if it is transmitting as much scheduled data as allowed by the serving grant on each stream. WTRU 102 may check if it is transmitting as much data as scheduled grant on the primary stream. WTRU 102 may check if WTRU 102 is transmitting as much data as scheduled grant on the primary stream and as much data as allowed by the allocated power considering the offset on the secondary stream.

In the second criterion for the setting of the happy bit, WTRU 102 may be configured to check if it has enough power available to transmit a higher data rate (e.g., higher E-TFCI). For rank-2 transmission, the set of supported E-TFCIs are calculated by the E-TFC restriction procedure assuming that the available power for E-DCH may be split over both streams. WTRU 102 may check whether WTRU 102 has enough power available to transmit at a higher data rate on the primary stream assuming rank-2 transmission. WTRU 102 may check whether WTRU 102 has enough power available to transmit at a higher data rate on the primary and secondary streams.

The second criterion may be used by the network to determine whether WTRU 102 has enough power available to increase its data rate. In the current context where WTRU 102 may be configured to transmit the primary and secondary stream at the same power, when assuming rank-2 transmission the two examples above are equivalent. Thus if WTRU 102 has enough power to increase the E-TFCI on the primary stream assuming rank-2 transmission then it will by definition be able to transmit with higher power also on the secondary stream. If it does not have enough power on the primary stream, then increasing the SG will not increase the data rate.

In the rank-2 case, even if the SG is increased, WTRU 102 may not be able to increase the data rate on the secondary stream as the rate depends on the channel conditions which may have deteriorated. However since WTRU 102 has no instant knowledge of the uplink channel conditions, the setting of the happy bit may not take into considerations possible changes in secondary stream offset.

In the third criterion, WTRU 102 may determine if the buffer can be emptied within a period of time given the current grants. In this example, WTRU 102 may determine if the buffer can be emptied within the configured amount of time assuming that the current conditions of serving grant, secondary stream offset, and HARQ process activation are maintained. More specifically, for rank-2 transmission, the criterion may be defined as follows: if there is more than one stream transmission, based on the same power offset as the one selected in E-TFC selection on each stream to transmit data in the same TTI as the happy bit, the total E-DCH buffer status (TEBS) may need more than Happy_Bit_Delay_Condition ms to be transmitted with the current (Serving_Grant×the ratio of active processes to the total number of processes on the primary stream) plus ((Serving_Grant−secondary stream offset)×the ratio of active processes to the total number of processes on the secondary stream).

In another example, WTRU 102 may be configured to use the virtual serving grant such that the criterion becomes: based on the same power offset as the one selected in E-TFC selection on each stream to transmit data in the same TTI as the happy bit, the total E-DCH buffer status (TEBS) may need more than Happy_Bit_Delay_Condition ms to be transmitted with the current (Serving_Grant×the ratio of active processes to the total number of processes on the primary stream) plus (Virtual_Serving_Grant×the ratio of active processes to the total number of processes on the secondary stream), where Virtual_Serving_Grant may be equivalent to Virtual_SS_SG.

WTRU 102 may then be configured to set the value of the happy bit on the (primary) E-DPCCH during rank-2 transmissions to “Happy” if any of the criteria above is not met. Otherwise, WTRU 102 may be configured to set the value of the happy bit on the E-DPCCH during rank-2 transmission to “Unhappy”.

WTRU 102 may use this method for determining the value of the happy bit when it is configured with UL MIMO operations and rank-2 transmission is activated. WTRU 102 may also use these criteria to set the happy bit on the E-DPCCH when transmitting with rank-1 even when rank-2 transmission is activated and allowed by any one of Node-Bs 140ₐ-140_{c} (e.g., due to power-limitations, buffer-limit, or other). WTRU 102 may also be configured to transmit this value of the happy bit on the S-E-DPCCH happy bit field (during rank-2 transmissions) and use the value of the happy bit on the (primary) E-DPCCH.

Examples for determining the happy bit indicating rank-1 happiness during rank-2 transmission are disclosed hereafter. WTRU 102 may determine whether or not it would be “happy” if configured with rank-1 transmission instead. This additional information may be used by the network, for example, to optimize the radio resource. A WTRU that may be “happy” with rank-2 transmission may also be happy with rank-1 transmission. In such case, the network may configure WTRU 102 for rank-1 to optimize the radio resource. To set the secondary stream happy, WTRU 102 may use a criterion assuming a rank-1 transmission (e.g., the serving grant and supported E-TFCIs are calculated according to rank-1 transmissions). For example, WTRU 102 may set the happy bit on the S-E-DPCCH during rank-2 transmissions to this value.

Examples for determining the secondary stream happiness indication are disclosed hereafter. WTRU 102 may set the value of the happy bit on the S-E-DPCCH according to the following criteria: WTRU 102 is transmitting as many bits as allowed by the serving grant (secondary stream offset on the secondary stream), WTRU 102 has enough power to transmit at a higher rate on the secondary stream according to the available power for the secondary stream, and if there is more than one stream transmission, based on the same power offset as the one selected in E-TFC selection on each stream to transmit data in the same TTI as the happy bit, the TEBS may need more than Happy_Bit_Delay_Condition ms to be transmitted with the current (Serving_Grant×the ratio of active processes to the total number of processes on the primary stream) plus ((Serving_Grant−secondary stream offset) the ratio of active processes to the total number of processes on the secondary stream). Equivalently, the expression “(Serving_Grant−secondary stream offset)” may also be replaced by the expression “(Virtual_Serving_Grant)” or “(Virtual_SS_SG)”.

FIG. 3B shows a process to determine a rank for an uplink MIMO transmission in accordance with examples given herewith. WTRU 102 may determine if rank-2 MIMO transmissions are possible with its current capabilities and configuration (334). If it is not possible, WTRU 102 may be configured to fall back to rank-1 uplink transmission mode (336). WTRU 102 may subsequently use legacy E-TFC selection procedures to determine uplink transmission formats (338). On the contrary, if WTRU 102 can perform rank-2 MIMO transmissions it may subsequently transmit using or as a rank-2 MIMO (340).

FIG. 3C shows a process to determine E-DCH transport format combinations (E-TFCs) for a primary stream and a secondary stream in accordance with examples given herewith. WTRU 102 determines the E-TFC for a primary stream and if it can support rank-2 MIMO transmissions (342). WTRU 102 may then determine an E-TFC for a secondary stream (344). WTRU 102 may use rank-1 E-TFC selection if rank-2 criteria are not met (346). Examples of different rank-2 criteria are given above.

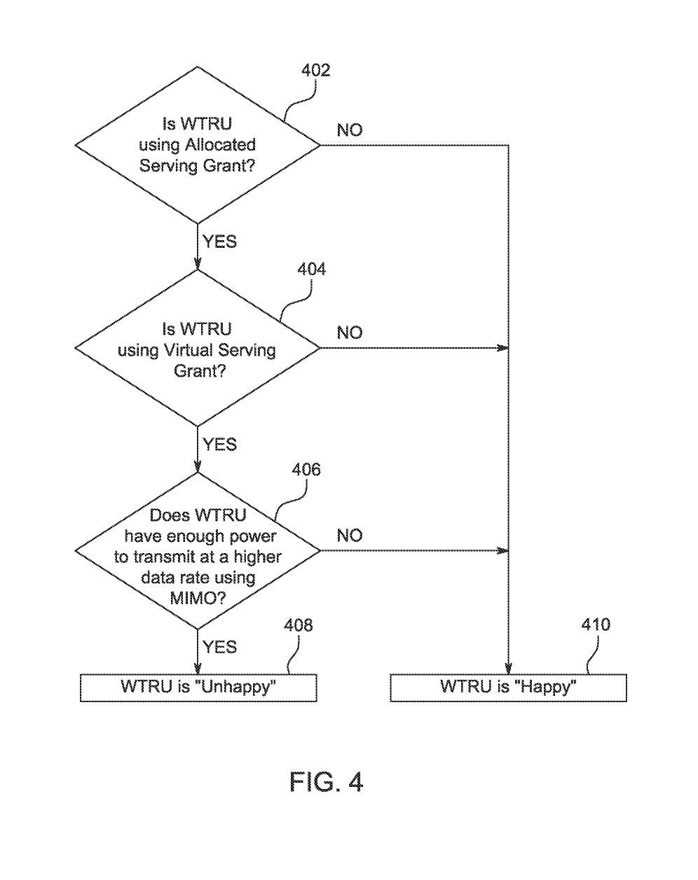

FIG. 4 shows an example of determining when a WTRU 102 is happy/unhappy with uplink resources allocated for MIMO transmissions in accordance with examples given herewith. WTRU 102 may be unhappy (408) in a current transmission if it is utilizing an allocated serving grant (402) and a virtual serving grant (404) and WTRU 102 has enough power to transmit at a higher data rate for a MIMO transmission (406). If any of these conditions are not met, WTRU 102 may be happy (410).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A wireless transmit/receive unit (WTRU), the WTRU comprising:
circuitry configured to receive rank and offset information from a Node-B;
circuitry configured to calculate a virtual serving grant (SG) that the WTRU is allowed to use in a rank-2 transmission of a secondary stream, using the offset information and transmit power of a primary stream; and
circuitry configured to send data on an enhanced dedicated channel (E-DCH) multiple-input multiple-output (MIMO) transmission to the Node-B, wherein the MIMO transmission includes the secondary stream based on the calculated virtual SG.

2. The WTRU of claim 1 wherein an E-DCH parameter specifies a minimum transport block size for the rank-2 transmission.

3. The WTRU of claim 1 wherein the rank information indicates a rank-2 allowed or a rank-2 not allowed value.

4. The WTRU of claim 1 wherein the rank information is applied on a transmission time-interval (TTI) basis.

5. The WTRU of claim 1 further comprising:
the WTRU is configured to perform an enhanced transmit format combination (E-TFC) selection procedure for rank-1 when an enhanced transport format combination indicator (E-TFCI) is less than a minimum transport block (TB) size for rank-2 transmissions.

6. The WTRU of claim 1 further comprising:
the circuitry further configured to send the secondary stream based on a configuration of an enhanced transmit format combination (E-TFC) selection procedure of the primary stream.

7. The WTRU of claim 1 further comprising:
circuitry configured to receive allocated resources from the Node-B; and
wherein a bit is set to unhappy when the WTRU in a current transmission is utilizing an allocated SG, utilizing the calculated virtual SG, and the WTRU has enough power to transmit at a higher data rate on the MIMO transmission.

8. The WTRU of claim 1 further comprising:
circuitry configured to provide an enhanced transmit format combination (E-TFC) selection procedure for another secondary stream for a retransmission; and
wherein when an E-TFC supported for another primary stream is smaller than a block size for retransmission on the another primary stream, the WTRU is configured to perform a rank-1 transmission.

9. The WTRU of claim 1 further comprising:
circuitry configured to utilize an enhanced transmit format combination (E-TFC) selection procedure for another secondary stream for a retransmission; and
wherein when a number of bits of data scheduled, based on a SG of another primary stream, is greater than a minimum transport block size (TBS) for rank-2 transmission, the WTRU is configured to use the calculated virtual SG.

10. The WTRU of claim 1 further comprising:
circuitry configured to estimate a normalized remaining power margin (NRPM) of the primary stream for a rank-2 transmission, wherein the primary stream is configured to use substantially half of the NRPM.

11. A method performed by a wireless transmit/receive unit (WTRU), the method comprising:
receiving, by the WTRU, rank and offset information from a Node-B;
calculating, by the WTRU, a virtual serving grant (SG) that the WTRU is allowed to use in a rank-2 transmission of a secondary stream, using the offset information and transmit power of a primary stream; and
sending, by the WTRU, data on an enhanced dedicated channel (E-DCH) multiple-input multiple-output (MIMO) transmission to the Node-B, wherein the MIMO transmission includes the secondary stream based on the calculated virtual SG.

12. The method of claim 11 wherein an E-DCH parameter specifies a minimum transport block size for the rank-2 transmission.

13. The method of claim 11 wherein the rank information indicates a rank-allowed or a rank-2 not allowed value.

14. The method of claim 11 wherein the rank information is applied on a transmission time-interval (TTI) basis.

15. The method of claim 11 further comprising:
performing, by the WTRU, an enhanced transmit format combination (E-TFC) selection procedure for rank-1 when an enhanced transport format combination indicator (E-TFCI) is less than a minimum transport block (TB) size for rank-2 transmissions.

16. The method of claim 11 further comprising:
sending, by the WTRU, the secondary stream based on a configuration of an enhanced transmit format combination (E-TFC) selection procedure of the primary stream.

17. The method of claim 11 further comprising:
receiving, by the WTRU, allocated resources from the Node-B; and
wherein a bit is set to unhappy when the WTRU in a current transmission is utilizing an allocated SG, utilizing the calculated virtual SG, and the WTRU has enough power to transmit at a higher data rate on the MIMO transmission.

18. The method of claim 11 further comprising:
providing, by the WTRU, an enhanced transmit format combination (E-TFC) selection procedure for another secondary stream for a retransmission; and
wherein when an E-TFC supported for another primary stream is smaller than a block size for retransmission on the another primary stream, the WTRU is configured to perform a rank-1 transmission.

19. The method of claim 11 further comprising:
utilizing, by the WTRU, an enhanced transmit format combination (E-TFC) selection procedure for another secondary stream for a retransmission; and
wherein when a number of bits of data scheduled, based on a SG of another primary stream, is greater than a minimum transport block size (TBS) for rank-2 transmission, the WTRU is configured to use the calculated virtual SG.

20. The method of claim 11 further comprising:
estimating, by the WTRU, a normalized remaining power margin (NRPM) of the primary stream for a rank-2 transmission, wherein the primary stream is configured to use substantially half of the NRPM.
